(19) United States
(12) Patent Application Publication
(10) Pub. No.: US 2004/0048157 A1
(43) Pub. Date: Mar. 11, 2004

(54) Lithium vanadium oxide thin-film battery

(76) Inventors: Bernd J. Neudecker, Littleton, CO (US); Bruce Lanning, Littleton, CO (US); Martin H. Benson, Littleton, CO (US); Joseph H. Armstrong, Littleton, CO (US)

Correspondence Address: PRESTON GATES ELLIS & ROUVELAS MEEDS LLP, 1735 NEW YORK AVENUE, NW, SUITE 500, WASHINGTON, DC, 20006, US

(21) Appl. No.: 10/238,905

(22) Filed: Sep. 11, 2002

(51) Int. Cl. H01M 4/48; H01M 4/66; B05D 5/12

(52) U.S. Cl. 429/231.2; 429/231.5; 429/245; 29/623.5; 427/126.3

(57) ABSTRACT

The manufacture and use of multilayer thin-film batteries, such as inverted lithium-free batteries is explained. The present invention provides a battery that may include a lithium vanadium oxide LiₓV₂O_{y} (0<x≦100, 0<y≦5) positive cathode or negative anode. The present invention may also provide for a thin-film battery that may be formed on a wide variety of substrate materials and geometries.

### GOVERNMENT INTEREST

This invention may have been made with Government support under Contracts Number MDA972-02-C-0021 and Number N00014-00-C-0479 awarded by DARPA. The Government may have certain rights in this invention.

### FIELD OF THE INVENTION

The present invention relates to the manufacture and use of multilayer thin-film batteries, such as inverted lithium-free batteries. The present invention provides a battery that may include a lithium vanadium oxide LiₓV₂O_{y} (0<x≦100, 0<y≦5) positive cathode or negative anode. The present invention may also provide for a thin-film battery that may be formed on a wide variety of substrate materials and geometries.

### DESCRIPTION OF THE ART

The present invention relates to several battery technology areas: solid-state thin-film secondary batteries, lithium-ion thin-film secondary batteries, lithium-free thin-film secondary batteries, inverted (or buried) thin-film secondary batteries, and twin-electrode thin-film secondary batteries.

Solid-state thin-film secondary batteries have been researched since the 1980's and have recently entered the manufacturing stage at battery companies such Infinite Power Solutions (IPS) in Golden, Colo. Lithium, lithium-ion, and lithium-free battery configurations have been described, for example, in U.S. patent application Ser. No. 10/109,991. Implantable medical devices, smart cards, radio frequency identification (RFID) tags, and other portable electronic devices requiring energy storage have been target markets for such lithium-based batteries.

Substrates for use in the fabrication of solid-state thin-film batteries have traditionally included ceramic, glass, and silicon planar wafers. More recently, the industry has sought solutions to provide solid-state thin-film batteries on flexible substrates such as metal foils and polymer films, with the goal of reducing the substrate thickness and incorporating the energy storage devices into tighter and more flexible packages. However, the use of polymeric substrates (advantageous for their flexibility and thinness) has been inhibited by the need for high-temperature annealing. Such annealing processes may require a high temperature (>>400° C.) to obtain high power and energy battery cells.

Certain patents discuss thin-film battery technology. For example, U.S. Pat. Nos. 6,218,049; 5,567,210; 5,338,625; 6,168,884; 5,445,906; and international patent application WO 9847196 all describe methods for fabricating thin-film deposited lithium batteries. Similarly, U.S. Pat. No. 5,512,147 describes a thin-film electrolyte employed in solid-state thin-film lithium batteries.

Additional examples of lithium and lithium-based solid-state thin-film battery configurations and apparatuses can be found in U.S. Pat. Nos. 5,552,242; 5,411,592; 5,171,413; 6,280,875; and international patent application WO 0060682. Other lithium polymer and laminate batteries involving thin-film components have been described in some detail, for example, U.S. Pat. Nos. 5,961,672; 5,110,696; 4,555,456; international patent application WO 0117052; and Japanese patent JP 60068558.

Much of the work in the area of lithium-ion secondary batteries has involved liquid non-aqueous electrolytes, polymeric electrode binders, and sintered powder electrodes. This work has involved the utilization of lithium transition metal oxide positive cathodes along with admixed graphitic forms of carbon and negative anodes, which mostly consist of some form of graphitic carbon and polymeric binder.

An improved lithium-ion secondary battery eliminates the metallic lithium anode. This elimination avoids the problem of the metallic lithium anode reacting with the non-aqueous liquid electrolyte and eventually developing lithium dendrites. The formation of dendrites is a problem because they can short-circuit the battery cells. In addition, the elimination of the metallic lithium anode also addresses handling and safety concerns. The combination of lithium-ion chemistry along with an all solid-state inorganic thin-film electrolyte, such as Lipon, enables solder reflow processing of thin-film batteries to printed circuit boards (PCBs). The solder reflow processing, however, is not viable with metallic lithium anodes because the temperatures needed during this process exceed the melting point of lithium metal (180° C.) for an extended period of time, which may damage or destroy the metal layers.

Lithium-ion thin-film batteries utilize lithium transition metal oxide electrode materials as the source of lithium ions and electrons. It is valuable to ensure that the electrode materials, usually only the positive cathode materials, are fabricated in a well lithiated state with a sufficient amount of electrochemically active lithium ions and electrons present. When this is accomplished, these electrode materials can serve as a lithium ion and electron source during the initial battery activation (usually accomplished by a charge step). Rarely, the lithium-ion anode material can be created with an as-fabricated excessive amount of lithium ions and electrons due to the increased air-sensitvity as more electrochemically active lithium ions and electrons are added to the lithium-ion anode material.

An example of a thin-film lithium-ion anode material is silicon tin oxynitride, described in U.S. Pat. No. 6,242,132. This anode material requires the use of a lithiated positive cathode material that serves as the only source of electrochemically active lithium ions and electrons in the battery.

The need for a lithiated positive cathode material poses a problem: battery capacity is reduced in this cell type due to the irreversible processes occurring in the first charge cycle. In that first cycle, lithium ions and electrons need to be irreversibly invested to activate most lithium-ion anode materials. This problem has been partially ameliorated by the use of subnitrides, for example SnNₓ and InNₓ, that form less of the irreversible compounds with lithium. This use of subnitrides is described by B. J. Neudecker and R. A. Zuhr in “Li-Ion Thin-Film Batteries with Tin and Indium Nitride and Subnitride Anodes MeNₓ (Me=Sn, In)”, Intercalation Compounds for Battery Materials, G.-A. Nazri, M. Thackeray, and T. Ohzuku, Editors, PV 99-24, p. 295ff, The Electrochemical Society Proceedings Series, Pennington, N.J. (2000).

Lithium-free secondary batteries have been described in U.S. Pat. No. 6,168,884. These batteries have many of the same needs and difficulties as the above described Lithium-ion secondary batteries, for essentially the same reasons.

Inverted (or “buried”) thin-film secondary batteries are valuable because of the well protected and low-impurity location of the air-sensitive anode between the substrate or anode current collector and the solid state electrolyte during battery charge. Of course, the battery still has to be encapsulated in order to protect the battery from the environment in the long term, as all lithium based batteries become air-sensitive during charge.

Twin electrode thin-film secondary batteries are discussed in, for example, U.S. Pat. No. 5,418,090. The described battery configuration allows the battery to charge in both directions if so desired. Also, this battery can inherently never be overdischarged unless forced by an external voltage source. This feature makes this battery “non-destroyable” (as long as the electrolyte is still intact). Contrarily in lithium anode batteries configured with LiCoO₂, LiNiO₂, LiMn₂O₄ and the like positive cathodes, the positive cathode can be severely damaged if the voltage falls below a certain threshold due to overdischarge or when left unattended for extended periods of time.

Non-lithiated vanadium oxide positive cathodes have been used in rechargeable batteries, either in thin-film or bulk form, for more than two decades. Unfortunately, these non-lithiated vanadium oxides cannot be used as positive cathodes in virtually any lithium-ion anode battery. Such lithium-ion anode batteries are usually provided with a lithium-ion anode (for instance, carbon, Sn₃N₄, or Li₄Ti₅O₂) that does not contain any electrochemically active lithium ions prior to the battery charge, and thus all the electrochemically active lithium must be provided by the positive cathode. A similar problem occurs in lithium-free batteries. In those batteries, the metallic lithium anode or the lithium-ion anode is replaced by a simple metallic anode current collector that does not form intermetallic compounds with lithium (for instance, Cu, Ni, Co, or Cr), yet also does not provide the lithium-free battery with any electrochemically active lithium. Thus, the lithium-free battery configuration also requires the positive cathode to provide all the electrochemically active lithium of the battery in the as-fabricated state prior to operation.

From a commercial standpoint, the lithium-ion anode and lithium-free anode battery configurations are very attractive. Indeed, today almost all lithium-based cell phone and laptop computer batteries are lithium-ion anode batteries. This popularity is due, in part, to their ability to circumvent the use and handling of metallic lithium during battery fabrication, and, when inorganic solid-state electrolytes such as Lipon are used, also to their ability to allow solder reflow processing of these batteries onto printed circuit boards by avoiding a low melting metallic lithium anode (melting point 180° C.). See, e.g., U.S. Pat. Nos. 6,168,884 and 6,242,132.

In view of this need for lithium-free and lithium-ion anode batteries, there is a desire in the battery industry to develop positive lithiated cathode materials to maximize the contained lithium ions and electrons that are electrochemically active. Such positive lithiated cathode materials may be used to fabricate lithium-ion anode and lithium-free anode batteries. Unfortunately, fabrication of lithiated vanadium oxide cathodes with a significant amount of electrochemically active lithium ions (prior to battery operation) has been difficult and expensive. In particular, the barriers to commercial success are present in the process of creating lithiated vanadium oxide positive cathodes in thin-film form. In that process the relatively simple deposition of V₂Oₓ (x≈5), accomplished either by reactive DC or RF magnetron sputtering of a metallic vanadium target in Ar—O₂ sputter gas atmosphere or by thermal vacuum evaporation from a V₂O₅ source, is followed by a post-deposition lithiation process, usually accomplished by thermal vacuum evaporation of metallic lithium on top of the V₂Oₓ (x≈5) layer. This post-deposition lithiation is difficult and time consuming due to lithium diffusion impeding effects (formation of lithium-rich tarnishing layers) on and inside the V₂Oₓ films. This problem has been slightly attenuated by annealing the V₂Oₓ/Li thin-film layer stack for several hours at 80° C. in a vacuum or argon glove box atmosphere, thereby promoting and completing the reaction between the two layers.

Lui et al. discusses the fabrication of lithiated vanadium oxide films via plasma-enhanced chemical vapor deposition using a mixture of a gaseous vanadium precursor (VOCl₃) and a commercially not available and complicated gaseous lithium precursor, (CF₃)₂CHOLi (lithium hexafluoroisopropoxide). Ping Liu et al., Solid State Ionics, 111 (1998) 145. This method is not cost-effective and has not been commercialized after more than four years since its introduction in 1998.

Therefore, there is a need to deposit lithiated vanadium oxide positive cathodes in one deposition step with larger thicknesses of up to, for example, 5 μm without any complicated time consuming post-deposition lithiation processes.

Certain patents and applications have discussed other electrochemical layers. For example, U.S. Pat. No. 5,851,696 discusses crystalline (monoclinic) Li_{y}V₆O_{13+z} (0≦y≦8; 0<z≦2) negative electrodes. That formula can be rewritten as Li_{y′}V₂O_{4 33+z′} (0≦y′≦2.67, 0<z′≦0.67). U.S. Patent Application No. 2001/0051125 discusses compositions of M₂₊ₓV₄O₁₁ (0≦x≦1, M=Cu, Li). That formula can be rewritten as M_{(1+x/2)}V₂O_{5.5}. U.S. Pat. No. 5,576,120 discusses LiₓV₅O_{12+y} (0.94≦x≦1.2, 0.97≦y≦1) compounds exclusively fabricated by a solid state reaction at elevated temperatures from a vanadium compound and a lithium compound. That formula can be rewritten as Li_{x′}V₂O_{4.8+y′} (0.38<y′≦0.4). Additionally, U.S. Pat. No. 6,322,928 discusses compositions and their use for electrodes of LiₓV_{3-d}M_{d}O_{y} (0<d≦1.0, 7.8<y≦8.2; x is “non-zero”, and x, y selected so that the average oxidation state of vanadium is at least 4.7; M represents at least two of the following elements: Mg, Al, Si, Sc, Ti, Cr, Mn, Fe, Co, Ni, Cu, Zn, Ge, Y, Zr, Nb, Ta, Mo, La, Hf, W, and mixtures thereof).

The production of lithium vanadium oxides has also been discussed. For example, U.S. Pat. No. 6,136,476 discusses lithium vanadium oxides exclusively fabricated by jet milling. Similarly, Japanese patent JP 6171947 discusses the fabrication of Li₁₊ₓV₃O₈ (0≦x≦0.5) exclusively accomplished by a non-thin-film solid state reaction. U.S. Pat. No. 6,177,130 discusses exclusively solution-fabricated lithiated vanadium oxides. Similarly, U.S. Pat. No. 5,512,214 discusses lithium vanadium oxides exclusively fabricated by solution methods using NH₄VO₃ and LiOH. U.S. Pat. No. 5,700,598 discusses ternary, amorphous lithiated vanadium oxides described by the formula LiₓM_{y}V_{z}O_{(x+5z+ny)/2} (M=metal; 0<x≦3; 0<y≦3; 1≦z≦4; n=2 or 3), exclusively fabricated in an aqueous solution using NH₄VO₃, NaVO₃, M(NO₃)ₙ, and an excess of a Li-salt. In contrast, U.S. Pat. No. 5,219,677 discusses lithium vanadium oxides exclusively fabricated by electrochemically lithiation of crystalline V₂O₅ inside a battery. U.S. Pat. No. 5,260,147 discusses exclusively crystalline LiₓM_{z}V_{2-z}O₅₋ₜ (M=Mo, Nb; 0<x≦3.2, 0≦z<1; 0≦t<0.5) electrode materials fabricated inside a battery by electrochemical lithiation (i.e. the electrode material was initially used in the non-lithiated state), or by chemical reaction of the non-lithiated material with organolithium compounds such as n-butyl lithium. U.S. Pat. No. 5,366,830 discusses lithiated vanadium oxides exclusively fabricated from non-lithiated V₂O₅ by electrochemical reaction inside a battery. Additionally, U.S. Pat. No. 5,567,548 discusses crystalline LiₓV₂O₅ (0.9≦x≦1.0) exclusively fabricated from V₂O₅ by electrochemical reaction inside a battery. That patent also suggests removing the so-fabricated LiₓV₂O₅ material from the fabrication battery and inserted into another battery, for example, a lithium-ion battery, in which the LiₓV₂O₅ material serves as the positive electrode.

Another example of a complicated and commercially unviable approach is described in U.S. Pat. No. 5,759,715. This patent discusses the use of a non-lithiated V₂O₅ positive cathode that is fabricated into a battery with a partially lithiated carbon negative anode. This approach is complicated and commercially unfavorable because the electroactive lithium has to be brought into the cell via a lithiated carbon anode. The lithiated carbon anode's fabrication is not considered cost-effective.

U.S. Pat. No. 5,418,090 discusses a battery in which both the positive cathode and the negative anode consists of LiₓMn_{y}O_{z}, either of the same or of different stoichiometry.

Scientific literature discusses fabrication methods and report on the synthesis of lithiated vanadium oxides in bulk form either accomplished by a chemical route (solid state reaction of a vanadium and a lithium compound at elevated temperatures, sol-gel reaction in solution followed by a final high-temperature anneal, or the reaction of organolithium, such as n-butyl lithium, with vanadium oxides) or an electrochemical route in a battery. Examples of these include the following: J. M. Cocciantelli et al., J. Solid State Chem., 93 (1991) 497; P. Rozier et al., Solid State Ionics, 98 (1997) 133), (D. W. Murphy et al., J. Electrochem. Soc., 126 (1979) 497; Rozier et al., Solid State Ionics, 98 (1997) 133; K. West et al., Mat. Res. Soc. Symp. Proc. Vol. 293 (1993) 39; J. M. Cocciantelli et al., Solid State Ionics, 50 (1992) 99; K. West et al., Solid State Ionics, 76 (1995) 15; Takahisa Shodai et al., J. Electrochem. Soc., 141 (1994) 2611). Additionally, scientific literature has discussed lithiated vanadium oxides in bulk form for use as negative anode materials in batteries. However, following the solid state reaction for the oxide, the described lithiated vanadium oxides had to be lithiated via an electrochemical route because the fully lithiated vanadium oxides for negative anode use could not be synthesized outside of the battery (D. Guyomard et al., J. Power Sources, 68 (1997) 692; S. Denis et al., J. Electrochem. Soc., 144 (1997) 4099. Additionally, scientific literature has discussed non-lithiated vanadium oxide thin films fabricated by reactive sputtering from a metallic vanadium target (Eun Jeong Jeon et al., J. Electrochem. Soc., 148 (2001) A318; Shinji Koike et al., J. Power Sources, 81-82 (1999) 581). In addition, the fabrication of non-lithiated vanadium oxide thin films by pulsed laser deposition (J. M. McGraw et al., Solid State Ioics, 113-115 (1998) 407) and plasma enhanced chemical vapor deposition (J. M. McGraw et al., Solid State Ionics, 113-115 (1998) 407; Ji-Guang Zhang et al., J. Electrochem. Soc., 145 (1998) 1889) has been discussed. However, all of these discussed vanadium oxides had to be activated by electrochemical lithiation inside a battery containing a metallic lithium negative anode. In-situ lithiation of these vanadium oxides was required because these films did not contain any lithium ions, as deposited, and consequently could not contribute any electrochemically active lithium to the battery.

Another piece of scientific literature, M. S. R. Khan et al., J. Appl. Phys, 69 (1991) 3231, discusses electrochromic and thermochromic LiₓVO₂ (0≦x≦0.43) thin films by reactive sputtering and post-deposition anneal to form VO₂ followed by an electrochemical lithiation process. This is another example of the undesirable and commercially non-viable two-step processes which the present invention solves.

Additionally, scientific literature discusses thin-film lithiated vanadium oxides: Se-Hee Lee et al.(J. Electrochem. Soc., 145 (1998) 3545; Electrochem. Solid State Lett., 2 (1999) 425). The described technique is the fabrication of the films by thermal evaporation of V₂O₅ followed by a post-deposition lithiation step of metallic Li by thermal evaporation at room temperature. However, such a process causes lithium-rich tarnishing lithium-rich layers to form on and inside the vanadium oxide thereby impeding the reaction (as measured by reaction and completion time). Also, the thicker the vanadium films are, the harder it is to complete the lithiation by that method. Consequently, this method is not commercially viable. Another piece of scientific literature, Ping Liu et al. (Solid State Ionics, 111 (1998) 145), discusses the only lithiated vanadium oxides that are fabricated in one step using a mixture of VOC₁₃ [vanadium oxytrichloride] and (CF₃)₂CHOLi [lithium hexafluoroisopropoxide] in a plasma enhanced chemical vapor deposition. However, this lithium component is not commercially available and, thus, requires synthesization, thereby reducing its commercial practicability.

### SUMMARY OF THE INVENTION

The present invention relates to the field of lithium-based solid-state thin-film secondary batteries with lithiated vanadium oxide electrodes described by an overall stoichiometry of, for example, LiₓV₂O_{y} (0<x≦100, 0<y≦5). The present invention also teaches how to fabricate lithiated vanadium oxide thin-films (e.g., LiₓV₂O_{y}, where 0<x≦100, 0<y≦5) in one single, non-solution based deposition step that may be cost-effective and may not require any further post-deposition anneal treatments. The lithiated vanadium oxide thin-films of the present invention may serve in batteries as, for example, a negative lithium-ion anode, a positive cathode, and as both anode and cathode in the same battery.

Using the lithiated vanadium oxide cathodes and anodes of the present invention, batteries may be built in at least seven different thin-film battery configurations (for example, Li, Li-ion, Li-free, inverted (or “buried”) Li, inverted (or “buried”) Li-ion, inverted (or “buried”) Li-free, and twin-LiₓV₂O_{y}). The lithiated vanadium oxide electrodes may be configured either with a conventional anode or cathode or with other vanadium oxide electrodes. For example, a battery may contain a negative lithiated vanadium oxide lithium-ion anode, a lithium ion electrolyte, and a positive lithiated vanadium oxide cathode. Alternatively, batteries may be configured with only one lithiated vanadium oxide electrode. For example, a battery may contain a negative lithiated vanadium oxide lithium-ion anode, a lithium ion electrolyte, and any positive electrode besides lithiated vanadium oxide, or may be configured with any negative anode besides lithiated vanadium oxide, a lithium ion electrolyte, and a positive lithiated vanadium oxide.

A specific embodiment of the present invention relates to three different inverted (or “buried”) battery configurations. In these inverted (or “buried”) configurations, the negative, very air-sensitive anode (which may be a Li anode, charged (i.e., substantially fully lithiated) Li-ion anode, or charged Li-free anode (which may include electroplated metallic Li)) may be protected between the solid state electrolyte and the substrate. A metallic anode current collector may be positioned between the substrate and the anode layer, if desired.

Another specific embodiment of the present invention relates to thin-film battery configurations with lithium-ion or lithium-free negative anodes (regardless of the placement of the anode in the battery structure), and lithiated vanadium oxide positive cathodes. In these embodiments, the lithiated vanadium oxide positive cathodes may serve as the sole source of electrochemically active lithium ions and electrons or may contribute, if, for example, configured with a lithium-ion negative anode that contains some electrochemically active lithium ions and electrons, to the overall electrochemically active lithium ion and electron concentration.

Due to the availability of low-temperature deposition of the LiₓV₂O_{y} films and thin-film electrodes, a wide variety of substrates may be used. These substrates may, for example, include metallic substrates, polymer-based substrates and polymer-based composites. The substrates may have a variety of geometries including, for example, planar, ribbon-like, and fibrous. In a specific embodiment of the present invention, the fabrication of multiple thin-film battery stacks on one or both sides of a substrate may be accomplished. The fabrication of the multi-stacked thin-film batteries may be accomplished using a polymer substrate coated with thin-film battery component layers in a web or drum coater.

The present invention solves the problems of the art by providing a cost-effective and straight-forward fabrication of as-deposited lithiated vanadium oxide films and provides for versatile use as a positive cathode and/or a negative anode material in various different, major thin-film battery configurations.

The lithiated vanadium oxide electrodes of the present invention may serve as both the positive cathode and/or the negative lithium-ion anode, due to their capability to accept or donate lithium ions and electrons. Thus, the following example battery configurations may be achieved: the metallic lithium anode configuration—in the battery component layer stack, the negative lithium anode may be located further away from the substrate than the positive cathode; the lithium-free anode configuration—in the battery component layer stack, the negative lithium-free anode, which may simply be a suitable metallic non-Li anode current collector, may be located further away from the substrate than the positive cathode; the lithium-ion configuration—in the battery component layer stack, the negative lithium-ion anode may be located further away from the substrate than the positive cathode; the inverted (or “buried”) metallic lithium anode configuration—in the battery component layer stack, the negative lithium anode may be located closer to the substrate than the positive cathode; the inverted (or “buried”) lithium-free anode configuration—in the battery component layer stack, the negative lithium-free anode, which may simply be a suitable metallic non-Li anode current collector, may be located closer to the substrate than the positive cathode or the lithium-free anode may be the substrate itself (e.g. a stainless steel foil substrate); the inverted (or “buried”) lithium-ion configuration—in the battery component layer stack, the negative lithium-ion anode may be located closer to the substrate than the positive cathode; and the lithiated vanadium oxide twin electrode configuration—both electrodes may be lithiated vanadium oxide and both electrodes may serve as the positive cathode or the negative anode, depending on the preceding charge direction.

Of the preceding configurations, the inverted (or “buried”) lithium-free configuration may be particularly advantageous, as it may provide the highest power and energy density per unit area. It may also automatically protect the very air-sensitive, in-situ electroplated metallic lithium between the substrate and the electrolyte at the end of the battery charge. However, the inverted configurations and twin configuration may require depositing the positive cathode on top of the already existing Lipon electrolyte layer. In order to avoid reaction with this Lipon electrolyte layer, the deposition temperature of the lithiated vanadium oxide should be limited during the actual deposition as well as in any optional post-deposition anneal process.

One embodiment of the present invention may include a method of fabricating an as-deposited lithiated vanadium oxide film. The fabricating process may include the steps of providing a source comprising an approximate overall composition of LiₓV₂O_{y}, wherein 0<x≦100 and 0<y≦5, and the source may be vacuum deposited. The source may include at least two such materials as Li₃VO₄, LiVO₃, and V₂O₃.

In certain embodiments of the present invention, the step of vacuum depositing may include such techniques as, for example, the following: reactive magnetron sputtering, non-reactive magnetron sputtering, reactive diode sputtering, non-reactive diode sputtering, reactive electron beam evaporation, non-reactive electron beam evaporation, reactive electron beam directed vapor deposition, non-reactive electron beam directed vapor deposition, reactive plasma enhanced electron beam directed vapor deposition, non-reactive plasma enhanced electron beam directed vapor deposition, reactive thermal evaporation, non-reactive thermal evaporation, plasma assisted thermal evaporation, cathodic arc deposition, ion beam deposition, plasma assisted ion beam deposition, pulsed laser deposition, chemical vapor deposition, plasma enhanced chemical vapor deposition, photo-chemical chemical vapor deposition, and molecular beam epitaxy.

In a particular embodiment of the present invention, the source material may contain a plurality of segments. These segments may, for example, be linearly or radially distributed, and are not required to be equal in size.

In one embodiment of the present invention, a method of fabricating an as-deposited lithiated vanadium oxide film may include the steps of providing a target comprising an overall composition of approximately LiₓV₂O_{y} (wherein 0<x≦100, 0<y≦5), and sputter depositing the target. The target may include at least two of the following: Li₃VO₄, LiVO₃, or V₂O₃. In another embodiment of the present invention, the target may include a plurality of separate targets.

A further embodiment of the present invention may include the step of adjusting the oxygen to lithium and vanadium ratio in the product that results from the step of sputter depositing the target, by annealing the product in an appropriate gas atmosphere with a temperature greater than about −195.8° C. In another embodiment of the present invention, the temperature for the annealing process may be greater than about 20° C. In another embodiment of the present invention, the temperature for the annealing process may be greater than about 100° C. In another further embodiment of the present invention, the oxygen to lithium and vanadium ratio in a product of the step of sputter depositing said target may be adjusted by sputter depositing said target in an atmosphere containing an appropriate O₂ partial pressure. In a further embodiment of the present invention, control of the O₂ partial pressure may be advantageously combined with the annealing process previously described.

In an embodiment of the present invention, the film that may be deposited by said step of sputter depositing may have one or more phases including such phases as glassy, amorphous, nano-crystalline, and crystalline. The film may, for example, have a thickness of between about 0.005 microns and about 20 microns. In another embodiment, the film may, for example, have a thickness of between about 0.005 microns and about 5 microns.

Yet another embodiment of the present invention may include the further step of providing supplemental target material to the target. The supplemental target material may include a material such as, for example, Li₃N, Li₂O, Li₂O₂, or Li. The supplemental target material may also, in certain embodiments, include a doping material, such as, for example, H, Be, Na, Mg, K, Ca, Rb, Sr, Cs, Ba, Al, Si, P, Ga, Ge, As, In, Sn, Sb, Tl, Pb, Bi, Sc, Ti, Cr, Mn, Fe, Co, Ni, Zn, Y, Zr, Nb, Mo, La, Hf, Ta, W, or Ce.

In one embodiment of the present invention, the supplemental target material may be provided by placing pellets of the supplemental target material on the target material. In another embodiment, the supplemental target material may be supplied in precut grooves in the target material. In a further embodiment of the present invention, the target may be a segmented target.

In a further embodiment of the present invention, the supplemental target material may include a material such as, for example, vanadium metal or V₂O₃.

One embodiment of the present invention may be a solid-state thin-film battery. This battery may, for example, include a substrate, a cathode layer on the substrate, an electrolyte layer on the cathode layer, and an anode layer on the electrolyte layer. The cathode layer may include, for example, LiₓV₂O_{y} (0<x≦100, 0<y≦5).

In a particular embodiment of the present invention, the anode layer may include a material such as, for example, Mg, B, Al, Ga, In, Tl, C, Si, Ge, Sn, Pb, P, As, Sb, Bi, Pd, Zn, Cd, Ag, Ir, Pt, Au, Li₄Ti₅O₁₂, lithium cobalt nitride, lithium manganese nitride, SnNₓ (0<x≦1.33), InNₓ (0<x≦1.0), ZnNₓ (0<x≦0.67), CuNₓ (0<x≦0.33), NiNₓ (0<x≦0.33), silicon tin oxynitride, SnOₓ (0<x≦2.0), InOₓ (0<x≦1.5), or PbOₓ (0<x≦2.0).

In certain embodiments of the present invention, the substrate may take one or more of a variety of forms such as, for example, foil, sheet, plate, ribbon, or round. The substrate may include a material such as, for example, a metal, an alloy, polyester, polyimide, polyamide, polycarbonate, polyurethane, polyalcohol, rubber, silicone, a ceramic, a semiconductor, silicon, graphite, or glass.

In a further embodiment of the present invention, the battery may further include a barrier layer between the substrate and the cathode layer. The barrier layer may, for example, include a material such as Lipon, graphitic carbon, diamond-like carbon, aluminum nitride, aluminum oxynitride, aluminum oxide, silicon nitride, silicon oxynitride, silicon monoxide, silicon dioxide, silicon carbide, titanium nitride, titanium oxynitride, titanium boride, titanium silicide, titanium carbide, vanadium nitride, vanadium carbide, vanadium silicide, vanadium boride, chromium nitride, chromium carbide, chromium boride, chromium silicide, yttrium nitride, yttrium carbide, yttrium boride, yttrium silicide, zirconium nitride, zirconium carbide, zirconium boride, zirconium silicide, niobium nitride, niobium carbide, niobium boride, niobium silicide, molybdenum nitride, molybdenum carbide, molybdenum boride, molybdenum silicide, hafnium nitride, hafnium carbide, hafnium boride, hafnium silicide, tantalum nitride, tantalum carbide, tantalum boride, tantalum silicide, tungsten nitride, tungsten carbide, tungsten boride, or tungsten silicide.

In a further embodiment of the present invention, the battery may also include a cathode current collector layer beneath the cathode layer. If, for example, there is no barrier layer, the cathode current collector layer may lie between the cathode layer and the substrate. The cathode collector layer may, for example, include a material such as Al, Ti, V, Cr, Mn, Fe, Co, Ni, Cu, Zn, Pd, Ag, Ir, Pt, Au, CuSn, phosphor bronze, or stainless steel.

Similarly, in a further embodiment of the present invention, the battery may include an anode current collector layer on the anode layer. The anode current collector layer may, for example, include a material such as Sc, Ti, V, Cr, Mn, Fe, Co, Ni, Cu, Nb, Mo, Hf, Ta, W, CuSn, phosphor bronze, or stainless steel.

In certain embodiments of the present invention, the anode layer may include a film having one or more phases such as glassy, amorphous, nano-crystalline, or crystalline.

In one embodiment of the present invention, for example, the electrolyte layer may have a thickness of about 0.1 microns to about 100 microns. The electrolyte layer may, for example, include a solid-state material such as LiAlF₄, LiAlCl₄, or polymer lithium electrolyte.

In another embodiment of the present invention, the electrolyte layer may include, for example, a non-aqueous liquid lithium electrolyte. If desired, the electrolyte layer may further include a solid-state separator.

In a particular embodiment of the present invention, the cathode layer may include a film having a thickness of between about 0.005 microns and about 20 microns. In another embodiment of the present invention the cathode layer may include a film having a thickness may be between about 0.005 microns and about 5 microns. In certain embodiments of the present invention, the cathode layer may include a film having one or more phases such as glassy, amorphous, nano-crystalline, or crystalline.

One embodiment of the present invention may be, for example, a solid-state thin-film battery including a substrate, an anode layer on the substrate, an electrolyte layer on the anode layer, and a cathode layer on the electrolyte layer. The anode layer may include LiₓV₂O_{y}, wherein 0<x≦100 and 0<y≦5. In a further embodiment of the present invention, the battery may also include a barrier layer between the substrate and the anode layer. In another embodiment of the present invention, the battery may include a cathode current collector layer on the cathode layer. Another embodiment of the present invention may include an anode current collector layer beneath the anode layer. In an embodiment including both an anode current collector layer and a barrier layer, the barrier layer may, for example, lie between the substrate and the anode current collector layer.

One embodiment of the present invention may be a solid-state thin-film battery including a substrate, an electrolyte layer on the substrate, and a cathode layer on the electrolyte layer. The cathode layer may, for example, include LiₓV₂O_{y} (0<x≦100, 0<y≦5).

In a further embodiment of the present invention, the battery may include a cathode current collector layer on the cathode layer. Additionally, the battery may include an anode current collector layer between the substrate and the electrolyte layer. Moreover, if desired, the battery may include an anode layer between the substrate and the electrolyte layer. If both an anode layer and an anode current collector layer are included, the anode current collector layer may, for example, lie between the substrate and the anode layer.

Another embodiment of the present invention may be a solid-state thin-film battery including a substrate, a cathode layer on the substrate, an electrolyte layer on the cathode layer, and an anode layer on the electrolyte layer. The anode layer may, for example, include LiₓV₂O_{y} (0<x≦100, 0<y≦5).

In a particular embodiment of the present invention, the cathode layer may, for example, include a material such as LiCoO₂, LiNiO₂, LiMn₂O₄, LiₓMn_{2-y}O₄ (1.2<x<2.2, y≈0.3), LiFePO₄, LiVOPO₄, LiTiS₂, LiMnCrO₄, LiCo₁₋ₓAlₓO₂ (0≦x≦1), V₂O₅, V₆O₁₃, VO₂, MnO₂, FePO₄, VOPO₄, TiS₂, or Mn_{0.5}Cr_{0.5}O₂. In certain embodiments of the present invention, the battery may further include a barrier layer between said substrate and said cathode layer. In other particular embodiments of the present invention, the battery may include a cathode current collector layer beneath the cathode layer. If both a cathode current collector and a barrier layer are included, the barrier layer may, for example, lie between the substrate and the cathode current collector layer. In another embodiment of the present invention, the battery may further include an anode current collector layer on the anode layer.

A further embodiment of the present invention may be a solid-state thin-film battery including a substrate, a first electrode layer on the substrate, an electrolyte layer on the first electrode layer, and a second electrode layer on the electrolyte layer. The first and second electrode layers may each, for example, include LiₓV₂O_{y} (0<x≦100, 0<y≦5).

In a particular embodiment of the present invention, the battery may also include a barrier layer between the substrate and the first electrode layer. In another embodiment of the present invention, the battery may include a first current collector layer beneath the first electrode layer. In certain embodiments, this first current collector layer may serve as a cathode current collector layer or an anode current collector layer. If both a first current collector layer and a barrier layer are included, the barrier layer may, for example, lie between the substrate and the first current collector layer. The battery may also further include a second current collector layer on the second electrode layer. The second current collector layer may in certain embodiments serve as an anode current collector layer or a cathode current collector layer. There is no requirement that the first current collector layer be present in order to include the second current collector layer.

One embodiment of the present invention may be a solid-state thin-film battery system including a substrate having a first side and a second side, a first electrode layer on the first side of the substrate, a first electrolyte layer on the first electrode layer, a second electrode layer on the first electrolyte layer, a third electrode layer on the second side of the substrate, a second electrolyte layer on the third electrode layer, and a fourth electrode layer on the second electrolyte layer. One or more of the four electrode layers may include LiₓV₂O_{y} (0<x≦100, 0<y≦5). The first electrode layer, first electrolyte layer, and second electrode layer may together be viewed as a first battery, and the third electrode layer, second electrolyte layer, and fourth electrode layer may together be viewed as a second battery.

In one embodiment of the present invention, the first battery may be adapted to electrically cycle in parallel with the second battery. In another embodiment of the present invention, the first battery may be adapted to electrically cycle in series with said second battery.

One embodiment of the present invention is a method of manufacturing a solid-state thin-film battery including the steps of providing a substrate, depositing a cathode layer on the substrate, depositing an electrolyte layer on the cathode layer, and depositing an anode layer on the electrolyte layer. The cathode layer may, for example, include LiₓV₂O_{y} (0<x≦100, 0<y≦5).

In particular embodiments of the present invention, the method may include the further step of adjusting the oxygen to lithium and vanadium ratio in the cathode layer by annealing the cathode layer in an appropriate gas atmosphere with a temperature greater than about −195.8° C. In another embodiment, the annealing temperature may, for example, be greater than about 20° C. In yet another embodiment, the annealing temperature may, for example, be greater than about 100° C.

In a particular embodiment of the present invention, the step of depositing a cathode layer may be performed by a technique such as, for example, reactive magnetron sputtering, non-reactive magnetron sputtering, reactive diode sputtering, non-reactive diode sputtering, reactive electron beam evaporation, non-reactive electron beam evaporation, reactive electron beam directed vapor deposition, non-reactive electron beam directed vapor deposition, reactive plasma enhanced electron beam directed vapor deposition, non-reactive plasma enhanced electron beam directed vapor deposition, reactive thermal evaporation, non-reactive thermal evaporation, plasma assisted thermal evaporation, cathodic arc deposition, ion beam deposition, plasma assisted ion beam deposition, pulsed laser deposition, chemical vapor deposition, plasma enhanced chemical vapor deposition, photo-chemical chemical vapor deposition, or molecular beam epitaxy.

One embodiment of the present invention is a method of manufacturing a solid-state thin-film battery including the steps of providing a substrate, depositing an electrolyte layer on the substrate, and depositing a cathode layer on the electrolyte layer. The cathode layer may, for example, include LiₓV₂O_{y} (0<x≦100, 0<y≦5).

One embodiment of the present invention is a method of manufacturing a solid-state thin-film battery including the steps of providing a substrate, depositing a cathode layer on the substrate, depositing an electrolyte layer on the cathode layer, and depositing an anode layer on the electrolyte layer. The anode layer may, for example, include LiₓV₂O_{y} (0<x≦100, 0<y≦5). In certain embodiments, the cathode layer may include a material such as LiCoO₂, LiNiO₂, LiMn₂O₄, LiₓMn_{2-y}O₄ (1.2<x<2.2, y≈0.3), LiFePO₄, LiVOPO₄, LiTiS₂, LiMnCrO₄, LiCo₁₋ₓAlₓO₂ (0≦x≦1), V₂O₅, V₆O₁₃, VO₂, MnO₂, FePO₄, VOPO₄, TiS₂, or MnO_{0 5}Cr_{0.5}O₂.

In certain embodiments, the step of depositing an anode layer may include a technique such as, for example, reactive magnetron sputtering, non-reactive magnetron sputtering, reactive diode sputtering, non-reactive diode sputtering, reactive electron beam evaporation, non-reactive electron beam evaporation, reactive electron beam directed vapor deposition, non-reactive electron beam directed vapor deposition, reactive plasma enhanced electron beam directed vapor deposition, non-reactive plasma enhanced electron beam directed vapor deposition, reactive thermal evaporation, non-reactive thermal evaporation, plasma assisted thermal evaporation, cathodic arc deposition, ion beam deposition, plasma assisted ion beam deposition, pulsed laser deposition, chemical vapor deposition, plasma enhanced chemical vapor deposition, photo-chemical chemical vapor deposition, and molecular beam epitaxy.

One embodiment of the present invention may be a method of manufacturing a solid-state thin-film battery including the steps of providing a substrate, depositing an anode layer on the substrate, depositing an electrolyte layer on the anode layer, and depositing a cathode layer on the electrolyte layer. The anode layer may, for example, include LiₓV₂O_{y}, wherein 0<x≦100 and 0<y≦5.

Another embodiment of the present invention includes a method of manufacturing a solid-state thin-film battery including the steps of providing a substrate, depositing a first electrode layer on the substrate, depositing an electrolyte layer on the first electrode layer, and depositing a second electrode layer on the electrolyte layer. The first and second electrode layers may include, for example, LiₓV₂O_{y} (0<x≦100, 0<y≦5).

A further embodiment of the present invention is a method of manufacturing a solid-state thin-film battery system including the steps of providing a substrate having a first side and a second side, depositing a first electrode layer on the first side of the substrate, depositing a first electrolyte layer on the first electrode layer, depositing a second electrode layer on the first electrolyte layer, depositing a third electrode layer on the second side of the substrate, depositing a second electrolyte layer on the third electrode layer, and depositing a fourth electrode layer on the second electrolyte layer. One or more of the four electrode layers may, for example, include LiₓV₂O_{y} (0<x≦100, 0<y≦5).

It is an object of the present invention to provide, for example, for the non-solution fabrication of an as-deposited lithiated vanadium oxide film described by LiₓV₂O_{y} (0<x≦100, 0<y≦5).

It is also an object of the present invention to provide a battery having an as-deposited lithiated vanadium oxide film described by LiₓV₂O_{y} (0<x≦100, 0<y≦5). This film may be of use in the battery as an anode layer, a cathode layer, or as one of a pair of reversible electrode layers.

It is a further object of the present invention to provide a method of producing a thin-film battery, wherein fabrication and configuration may be completed in a single-pass, in-situ, multilayer vacuum process. This process may, for example, be a web or drum coating process using a polymer-based substrate, such as a pure polymer or composite containing polymer.

It is understood that both the foregoing general description and the following detailed description are exemplary and explanatory only and are not restrictive of the invention as claimed. The invention is described in terms of solid-state thin-film batteries; however, one skilled in the art will recognize other uses for the invention. The accompanying drawings illustrating an embodiment of the invention together with the description serve to explain the principles of the invention.

### BRIEF DESCRIPTION OF THE DRAWINGS

FIG. 1 is a graph depicting the discharge voltage profiles of a Li₂V₂O₅ positive thin-film cathode vs. Li⁺/Li at different current rates as a function of normalized discharge capacity to 1 cm² of active area and 1 μm of thickness.

FIG. 2 is a graph depicting the discharge capacity retention of a Li₂V₂O₅ positive thin-film cathode vs. Li⁺/Li as a function of cycle index.

FIG. 3 is a graph depicting the discharge voltage profiles of a battery with a Li V₂O₅ lithium-ion negative anode and a LiCoO₂ positive cathode.

FIG. 4 is a schematic diagram of an example single-pass continuous polymer web manufacturing process for LiₓV₂O_{y} twin electrode thin-film batteries.

FIG. 5 is a schematic diagram of an example single-pass continuous polymer drum coater manufacturing process for LiₓV₂O_{y} twin electrode thin-film batteries.

FIG. 6 is a cutaway diagram of an embodiment of the present invention employing a twin LiₓV₂O_{y} electrode battery design.

FIG. 7 is a cutaway diagram of an embodiment of the present invention employing two twin LiₓV₂O_{y} electrode batteries connected in series.

FIG. 8 is a cutaway diagram of an embodiment of the present invention employing two twin LiₓV₂O_{y} electrode batteries connected in parallel.

FIG. 9 is a cutaway side-view diagram of an embodiment of the present invention employing a twin LiₓV₂O_{y} electrode battery on an insulating substrate.

FIG. 10 is a cutaway side-view diagram of an embodiment of the present invention employing a twin LiₓV₂O_{y} electrode battery on a conducting substrate.

### DETAILED DESCRIPTION OF THE INVENTION

It is to be understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “a layer” is a reference to one or more layers and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. All references cited herein are incorporated by reference herein in their entirety.

The fabrication of a Li₂V₂O₅ film may be achieved, for example, by RF magnetron sputter depositing from a multi-phase sputter target consisting mainly of Li₃VO₄, LiVO₃, and V₂O₃ with an overall composition of approximately Li₂V₂O₅. The sputter gas atmosphere may be, for example, approximately 20 mTorr argon at an approximate 100 sccm flow rate and the target-to-substrate distance may be approximately 5 cm. Under these conditions, for example, the temperature on the substrate (which may, for example, be an approximately 250 μm thick alumina plate) surface with which it was associated, as measured by a vacuum technology temperature tap affixed to the backside of the substrate, may not exceed 90° C. after 6 hours of continuous deposition. The stoichiometry of the resulting X-ray amorphous Li₂V₂O₅ film may be verified by inductively coupled plasma spectroscopy and standard-calibrated energy dispersive spectroscopy, confirming the as-deposited ratio of Li/V≈1.

The as-deposited amorphous film composition may be changed to Li₂₊ₓV₂O₅ (0<x≦98) by adding Li₃N, Li₂O, Li₂O₂, or Li to the sputter target, in precut target grooves or by placing thin pellets on the Li₂V₂O₅ target surface. Alternatively, the additional material may be provided as segments of a single target.

The as-deposited amorphous film composition may be changed to Li₂₋ₓV₂O_{5-y} (0<x<2, 0<y≦5) by adding vanadium metal or V₂O₃ to the sputter target, either in precut grooves, as thin pellets on the target surface, or into the bulk of the ceramic tile. Alternatively, the additional material may be provided as segments of a single target.

A solid-state thin-film lithium anode battery may be constructed using, for example, an approximately 250 μm thick alumina substrate, an approximately 0.3 μm thick Au current collector (electron beam evaporated), an approximately 1.0 μm thick Li₂V₂O₅ film fabricated as previously described and serving as the positive cathode, an approximately 1.5 μm Lipon (lithium phosphorus oxynitride, which may be fabricated by RF magnetron sputtering from a Li₃PO₄ target in a reactive N₂ sputter gas atmosphere) solid state electrolyte, an approximately 3 μm thick metallic lithium anode (which may be thermally evaporated at about 10⁻⁷ Torr), and an approximately 0.3 μm thick Ni anode current collector (electron beam evaporated).

The present invention teaches, for example, the fabrication of lithiated vanadium oxide films described by an overall stoichiometry of approximately LiₓV₂O_{y} (0<x≦100, 0<y≦5). Used in secondary thin-film batteries, these films are capable of accepting and donating lithium ions and electrons in their as-fabricated state and may therefore serve as a negative lithium-ion anode, or a positive cathode.

In consequence of their versatility, these films may be used in a variety of different battery configurations. Seven main thin-film battery configurations may be given as examples. Three traditional and corresponding inverted (or “buried”) battery configurations are explained below, as is the twin vanadium oxide electrode configuration. In the inverted configurations, the negative, very air-sensitive anode is protected between the solid state electrolyte and the substrate during battery charge. In some cases the substrate may be coated with an anode current collector. The use of these lithiated vanadium oxide films as positive cathodes together with metallic lithium, lithium-ion, or lithium-free negative anodes permits thin-film batteries to be feasible. This remains the case even when the anode material contains insufficient electrochemically active lithium. Indeed, by the use of these films, there is no requirement that the anode contain any electrochemically active lithium. The present invention also teaches how to fabricate multiple thin-film battery stacks on one or both sides of a polymer substrate. This process may also be accomplished in a web or drum coater.

The present invention may enable non-solution (neither aqueous nor organic solvents are required) fabrication of as-deposited lithiated vanadium oxide films without the intermediate deposition of a non-lithiated vanadium oxide. The resultant thin films may have an overall stoichiometry of approximately LiₓV₂O_{y} (0<x≦100, 0<y≦5). The thickness of said films may, for example, be between about 0.005 μm and about 20 μm. More preferably, the thickness of the films may be between about 0.005 μm and about 5 μm.

The batteries of the present invention may have a solid-state thin-film electrolyte such as Lipon, LiAlF₄, LiAlCl₄, or polymer lithium electrolyte. This solid-state thin-film electrolyte may have a thickness of, for example, about 0.1 μm to about 100 μm. In other embodiments, the batteries may have a non-aqueous liquid lithium electrolyte, either with or without a solid-state separator.

The lithiated vanadium oxide films of the present invention may be glassy, amorphous, nano-crystalline, crystalline, or combinations thereof. For example, one or more crystalline phases may be embedded in an amorphous matrix, or one or more nano-crystalline phases may co-exist with a crystalline phase.

The lithiated vanadium oxide films of the present invention may be formed by a variety of vacuum deposition techniques. These techniques may include reactive or non-reactive magnetron sputtering, reactive or non-reactive diode sputtering, reactive or non-reactive electron beam evaporation, reactive or non-reactive electron beam directed vapor deposition, reactive or non-reactive plasma enhanced electron beam directed vapor deposition, reactive or non-reactive thermal evaporation, plasma assisted thermal evaporation, cathodic arc deposition, ion beam deposition, plasma assisted ion beam deposition, pulsed laser deposition, chemical vapor deposition, plasma enhanced chemical vapor deposition, photo-chemical chemical vapor deposition, and molecular beam epitaxy.

The lithiated vanadium oxide films of the present invention may be fabricated in a particularly economical fashion by magnetron sputter deposition using a single oxide sputter target that may have an overall lithium to vanadium ratio similar to that of the intended overall thin-film electrode stoichiometry. Moreover, the single sputter target may contain oxide ions of any concentration, as the concentration of oxide ions in the growing electrode film may be modified by adjusting the partial pressure of oxygen in the reactive sputter gas atmosphere. It may be advantageous to choose a sputter target composition of LiₓV₂O_{y}, where the stoichiometric parameter ratio of approximately 2/y is very close to that of the intended thin-film electrode composition.

The oxygen to lithium and vanadium ratio (O/(Li+V)) in the films of the present invention may be adjusted by post-deposition anneal in an appropriate gas atmosphere of, for example, Ar—H₂—N₂—O₂—H₂O—CO₂ in which the partial pressure of each gas may be varied from 0-100%. This variation may be controlled either inside or outside the vacuum chamber. Appropriate temperatures for this process may be above the boiling point temperature of nitrogen (−195.8° C.), more preferably above 20° C., and yet more preferably above 100° C.

Another economical way of fabricating the lithiated vanadium oxide films of the present invention is by magnetron sputter deposition using two sputter targets in a dual sputter deposition. One target may provide the lithium atoms and ions while the other target may provide the vanadium atoms and ions for the LiₓV₂O_{y} (0<x≦100, 0<y≦5) electrode film. Alternatively, one target may contain both lithium and vanadium while the second target may adjust the lithium to vanadium ratio to the desired value. The choice and combination of the mutual sputter parameters (sputter gas pressure, composition, and flow rate) and the independent sputter parameters (power applied to the individual sputter cathodes) may determine the overall Li/V ratio in the LiₓV₂O_{y} (0<x≦100, 0<y≦5) film.

None of the sputter targets are required to (although they are permitted to) contain oxide ions, as the concentration of oxide ions in the growing electrode film may be effectively controlled by adjusting the partial pressure of oxygen in the sputter gas atmosphere. However, preferably at least one of the sputter targets may contain oxide ions. For example, a first target may contain Li₂O, Li₂O₂, V₂O₅, V₂O₃, or LiVO₃ and a second target may contain V or Li. More preferably both targets may contain oxide ions. For example, a first target may contain Li₂O and a second target may contain V₂O₅. For another example, a first target may contain LiVO₃ and a second target may contain Li₂O.

In certain embodiments of the present invention, a segmented target may be used. For example, a round segmented target may resemble a cake with each slice of the cake providing a different material. A rectangular segmented target, for example, may resemble a checker board in which each field provides a different (or in another example, alternating) material. During sputter deposition, atoms and ions from the different target materials may then be sputtered into the plasma. The growing film may consequently be fairly homogeneous due to the mediating plasma between the geometrically inhomogeneous target surface and the generally homogeneous deposited film surface.

The lithium-based thin-film batteries of the present invention may, for example, have one of the following battery configurations using LiₓV₂O_{y} (0<x≦100, 0<y≦5) as the positive battery cathode that accepts lithium ions and electrons during battery discharge and donates lithium ions and electrons during battery charge: the normal metallic lithium anode configuration; the normal lithium-free anode configuration; the normal lithium-ion anode configuration; the inverted (or “buried”) metallic lithium anode configuration; the inverted (or “buried”) lithium-free configuration; or the inverted (or “buried”) lithium-ion configuration. An example of the normal metallic lithium anode configuration may be the following: substrate/barrier layer (optional; inclusion may be dependent on substrate choice)/cathode current collector (optional)/LiₓV₂O_{y} positive cathode/electrolyte/metallic lithium anode/anode current collector (optional)/encapsulation (optional). An example of the normal lithium-free anode configuration may be the following: substrate/barrier layer (optional; inclusion may be dependent on substrate choice)/cathode current collector (optional)/LiₓV₂O_{y} positive cathode/electrolyte/metallic anode current collector (optional—preferably composed of materials that do not form intermetallic compounds with Li)/encapsulation (optional). An example of the normal lithium-ion anode configuration may be the following: substrate/barrier layer (optional; inclusion may be dependent on substrate choice)/cathode current collector (optional)/LiₓV₂O_{y} positive cathode/electrolyte/lithium-ion anode/anode current collector (optional)/encapsulation (optional). An example of the inverted metallic lithium anode configuration may be the following: substrate/barrier layer (optional; inclusion may be dependent on substrate choice)/anode current collector (optional)/metallic lithium anode/electrolyte/LiₓV₂O_{y} positive cathode/cathode current collector (optional)/encapsulation (optional). An example of the inverted lithium-free configuration may be the following: substrate/barrier layer (optional; inclusion may be dependent on substrate choice)/anode current collector (optional; preferably composed of materials that do not form intermetallic compounds with Li)/electrolyte/LiₓV₂O_{y} positive cathode/cathode current collector (optional)/encapsulation (optional). An example of the inverted lithium-ion configuration may be the following: substrate/barrier layer (optional; inclusion may be dependent on substrate choice)/anode current collector (optional)/lithium-ion anode/electrolyte/LiₓV₂O_{y} positive cathode/cathode current collector (optional)/encapsulation (optional).

The lithium-based thin-film batteries of the present invention may, for example, have one of the following battery configurations when using LiₓV₂O_{y} (0<x≦100, 0<y≦5) as the negative Li-ion battery anode that accepts lithium ions and electrons during battery charge and donates lithium ions and electrons during battery discharge: the normal lithium-ion anode configuration; or the inverted (or “buried”) lithium-ion configuration. An example of the normal lithium-ion anode configuration may be the following: substrate/barrier layer (optional; inclusion may be dependent on substrate choice)/cathode current collector (optional)/positive cathode/electrolyte/LiₓV₂O_{y} lithium-ion anode/anode current collector (optional)/encapsulation (optional). An example of the inverted lithium-ion configuration may be the following: substrate/barrier layer (optional; inclusion may be dependent on substrate choice)/anode current collector (optional)/LiₓV₂O_{y} lithium-ion anode/electrolyte/positive cathode/cathode current collector (optional)/encapsulation (optional).

The lithium-based thin-film batteries of the present invention for which the positive cathode is LiₓV₂O_{y} (0<x≦100, 0<y≦5) may result, for example, in the following LiₓV₂O_{y} twin electrode configurations: the normal lithium-ion twin configuration; or the inverted (or “buried”) lithium-ion twin configuration. An example of the normal lithium-ion twin configuration may be the following: substrate/barrier layer (optional; inclusion may be dependent on substrate choice)/cathode current collector (optional)/LiₓV₂O_{y} positive cathode/electrolyte/LiₓV₂O_{y} negative Li-ion anode/anode current collector (optional)/encapsulation (optional). An example of the inverted lithium-ion twin configuration may be the following: substrate/barrier layer (optional; inclusion may be dependent on substrate choice)/anode current collector (optional)/LiₓV₂O_{y} negative Li-ion anode/electrolyte/LiₓV₂O_{y} positive cathode/cathode current collector (optional)/encapsulation (optional).

The initial (as-deposited) stoichiometry of the positive LiₓV₂O_{y} cathode may be the same as that of the negative LiₓV₂O_{y} lithium-ion anode or may be different. The specific polarity of the individual LiₓV₂O_{y} electrodes may be determined by the direction in which the battery is charged, including the subsequent discharge. The polarity may be changed at any time when charging in the reversed direction. Thus the “normal” configuration may be converted into the “inverted” configuration and vice versa. Such a battery may, therefore, be discharged to 0 V without being destroyed. In other words these batteries may not permit overdischarge as 0 V may be both the lowest voltage and yet still a safe voltage.

The substrates used in connection with the batteries of the present invention may be provided either in foil form (for example, about 1 μm to about 127 μm), in sheet or plate form (for example, about 127 μm to about 10 cm), in ribbon form (for example, about 1 μm to about 127 μm thick and having a length to width ratio of larger than about 3) or round form (for example, fiber of about 1 μm to about 1 mm in diameter, wire, rod or tube). The materials may be metallic substrates (metal and alloys), polymeric substrates (polyester, polyimide, polyamide, polycarbonate, polyurethane, polyalcohol, rubber, silicones, and any block co-polymers thereof), ceramics, semi-conductors, silicon, graphite, glass, and any combinations thereof mixed together to form composites materials. The substrates may be electronically insulating, semi-conducting or conducting.

A barrier layer may help to prevent undesireable chemical interactions produced by diffusion through various layers. The barrier layer may include such materials as Lipon, carbon (graphitic or diamond-like), aluminum nitride, aluminum oxynitride, aluminum oxide, silicon nitride, silicon oxynitride, silicon monoxide, silicon dioxide, silicon carbide, titanium nitride, titanium oxynitride, titanium boride, titanium silicide, titanium carbide, vanadium nitride, vanadium carbide, vanadium silicide, vanadium boride, chromium nitride, chromium carbide, chromium boride, chromium silicide, yttrium nitride, yttrium carbide, yttrium boride, yttrium silicide, zirconium nitride, zirconium carbide, zirconium boride, zirconium silicide, niobium nitride, niobium carbide, niobium boride, niobium silicide, molybdenum nitride, molybdenum carbide, molybdenum boride, molybdenum silicide, hafnium nitride, hafnium carbide, hafnium boride, hafnium silicide, tantalum nitride, tantalum carbide, tantalum boride, tantalum suicide, tungsten nitride, tungsten carbide, tungsten boride, tungsten suicide, or any solid solution or ternary or quaternary compound thereof.

The cathode current collectors used in connection with the present invention may, for example, be made of such materials as Al, Ti, V, Cr, Mn, Fe, Co, Ni, Cu, Zn, Pd, Ag, Ir, Pt, Au, CuSn, phosphor bronze, stainless steel, or any solid solution or intermetallic compound thereof.

The anode current collectors used in connection with the present invention may, for example, be made of such materials as Sc, Ti, V, Cr, Mn, Fe, Co, Ni, Cu, Nb, Mo, Hf, Ta, W, CuSn, phosphor bronze, stainless steel and any solid solution or intermetallic compound thereof.

The lithium-ion anodes used in connection with the present invention may, for example, be made of such materials as Mg, B, Al, Ga, In, Tl, C, Si, Ge, Sn, Pb, P, As, Sb, Bi, Pd, Zn, Cd, Ag, Ir, Pt, Au, CuSn, SnₓP_{y}Cu_{1-x-y} (0<x<0.1, 0<y<0.01) (phosphor bronze), Li₄Ti₅O₁₂, lithium cobalt nitride, lithium manganese nitride, SnNₓ (0<x≦1.33), InNₓ (0<x≦1.0), ZnNₓ (0<x≦0.67), CuNₓ (0<x≦0.33), NiNₓ (0<x≦0.33), silicon tin oxynitride, SnOₓ (0<x≦2.0), InOₓ (0<x≦1.5), PbOₓ (0<x≦2.0), or any solid solution, intermetallic compound, or mixed compound thereof.

The positive cathodes used in connection with the present invention may, for example, be made of such materials as LiCoO₂, LiNiO₂, LiMn₂O₄, LiₓMn_{2-y}O₄ (1.2<x<2.2, y≈0.3), LiFePO₄, LiVOPO₄, LiTiS₂, LiMnCrO₄, LiCo₁₋ₓAlₓO₂ (0≦x≦1), V₂O₅, V₆O₁₃, VO₂, MnO₂, FePO₄, VOPO₄, TiS₂, or MnO_{0 5}Cr_{0.5}O₂ and any solid solution or mixed compound thereof.

The encapsulation used in connection with the present invention may, for example, be made of such materials as inorganic or polymeric coatings, either as a single layer or a multilayer stack, either as a pure inorganic or a pure polymeric multilayer stack or as a mixed multilayer stack. The encapsulation may also, for example, be a hermetically sealed enclosure with electrical feedthroughs such as a metal can commonly used in bulk battery technology.

The battery system of the present invention may include a plurality of individual battery configurations on one or both sides of a substrate. These batteries on a single substrate may be designed to be cycled electrically in parallel or in series.

Additionally, the LiₓV₂O_{y} films of the present invention may be fabricated in a doped state with one of the following elements from the group M. Members of group M include H, Be, Na, Mg, K, Ca, Rb, Sr, Cs, Ba, Al, Si, P, Ga, Ge, As, In, Sn, Sb, Tl, Pb, Bi, Sc, Ti, Cr, Mn, Fe, Co, Ni, Zn, Y, Zr, Nb, Mo, La, Hf, Ta W, and Ce. The resulting overall film or electrode composition may, for example, be represented by LiₓV_{2-z}M_{z}O_{y} (0<x≦100, 0<y≦5, 0<z<1.0).

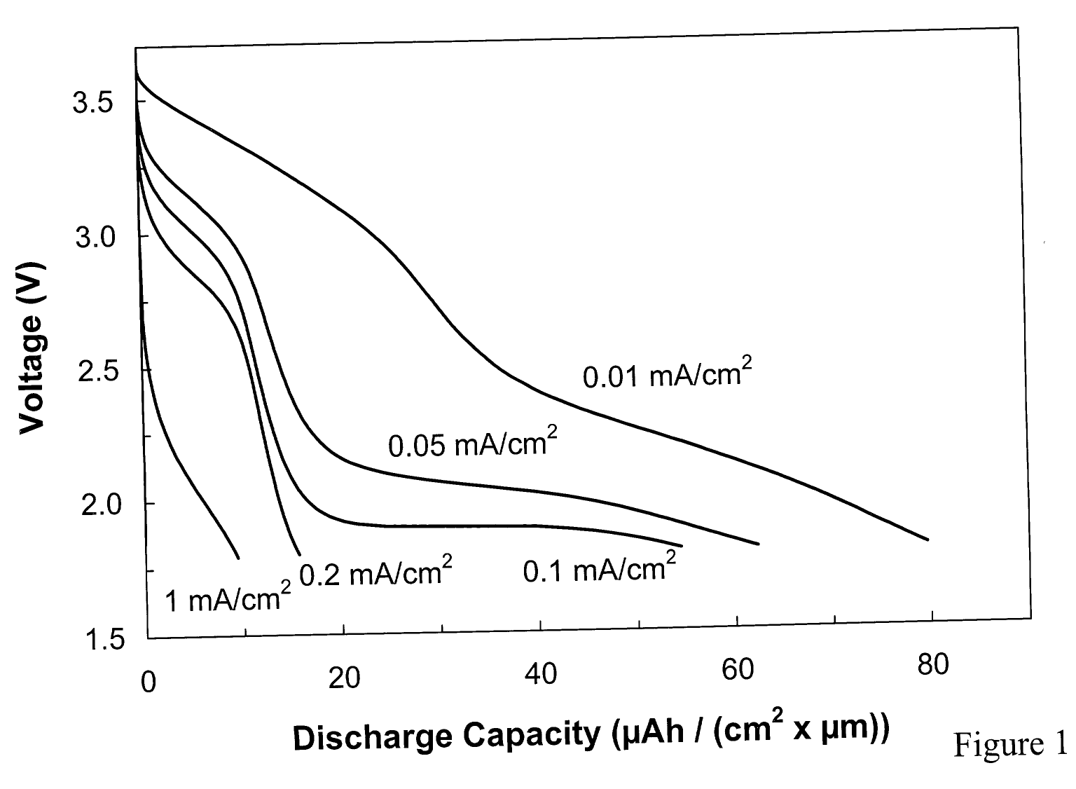

FIG. 1 depicts the results of testing such a battery in the voltage range of 3.8 and 1.8 V at current densities of up to 1 mA/cm² active Li₂V₂O₅ battery area at 21° C. in a hermetically sealed stainless steel tube equipped with feed-throughs and filled with argon atmosphere (overall impurity level below 10 ppm). The voltage profiles at different current densities are shown as a function of the discharge capacity which is normalized to 1 cm² active Li₂V₂O₅ area and 1 μm Li₂V₂O₅ thickness. For instance, at 1 mA/cm² the battery supplied continuous power of about 2.2 mW and 0.03 mWh, respectively, per 1 cm² and 1 μm of Li₂V₂O₅ positive cathode.

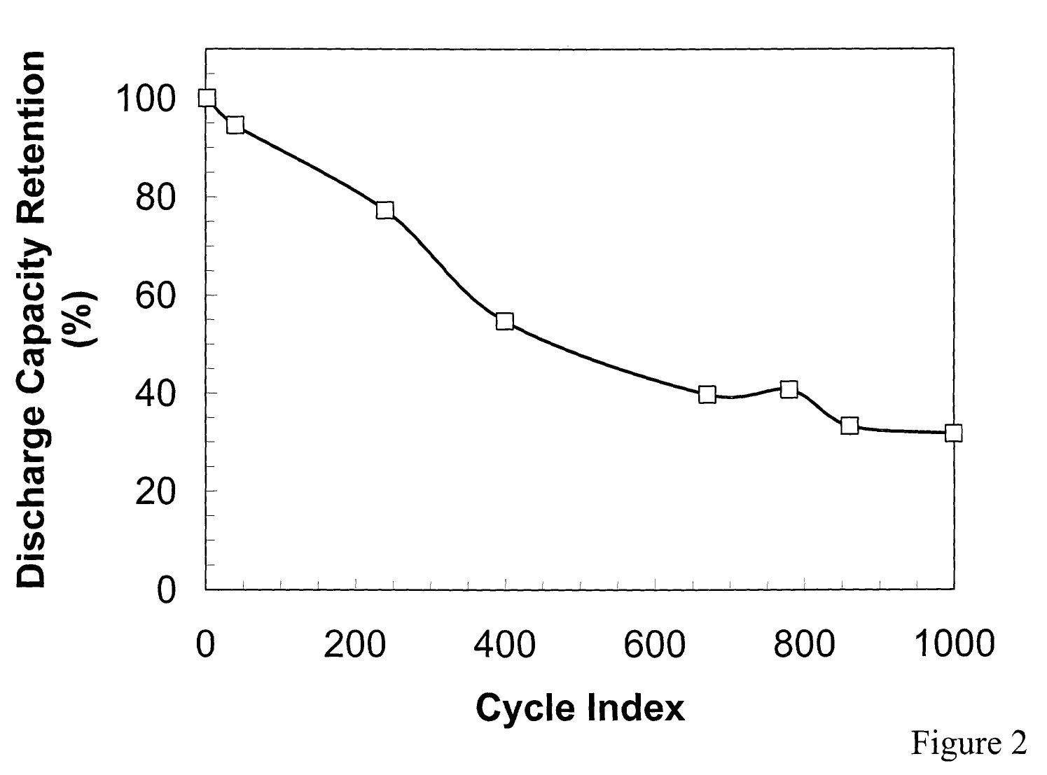

FIG. 2 depicts the results in terms of capacity retention of such a battery when it is cycled between 3.8 and 1.8 V at 1 mA/cm² (>100 C rate) and 21° C. The positive cathode, in this example, remained x-ray amorphous throughout its entire operational life.

A solid-state thin-film inverted (or “buried”) lithium-free battery may be constructed using, for example, a SiC fiber that is approximately 150 μm in diameter, an approximately 0.9 μm Cu anode current collector (which may be DC magnetron sputter deposited in an argon sputter gas atmosphere), an approximately 1.5 μm Lipon electrolyte layer (which may be fabricated as previously described), an approximately 0.4 μm Li₂V₂O₅ (which may be fabricated as previously described), an approximately 0.4 μm Cu cathode current collector (which may be DC magnetron sputter deposited in an argon sputter gas atmosphere), an approximately 0.4 μm Lipon protective overlayer, and a plastic encapsulation, which may be purchased off the shelf from such manufacturers as 3M. The active battery length may be about 5 cm and the active battery area may be about 0.24 cm². This inverted lithium-free battery was cycled at 0.03 mA/cm² between 3.8 and 1.0 V at 25° C. for more than 2000 cycles with an average capacity loss of 0.025% per cycle based on the initial discharge capacity.

A solid-state thin-film battery was constructed to test a Li₁V₂O₅ film on its lithium accepting capability. This Li₁V₂O₅ film was deposited in an argon sputter gas atmosphere by placing V₂O₅ thin pellets on the Li₂V₂O₅ sputter target that was described previously. Onto the substrate (250 μm thick alumina plate) was deposited a 0.3 μm thick Cu current collector (electron beam evaporated), the 1.0 μm Li₁V₂O₅ film, a 1.5 μm Lipon (fabricated as previously described) solid state electrolyte, a 3 μm metallic lithium anode (thermally evaporated at 10⁻⁷ Torr), and a 0.3 μm Ni anode current collector (electron beam evaporated). The battery was cycled in the voltage range between 1.5 and 0 V at current densities of 0.1 mA/cm² active Li₁V₂O₅ battery area at 22° C. in a hermetically sealed stainless steel tube equipped with feed-throughs and filled with argon atmosphere (overall impurity level below 10 ppm). The discharge voltage profile showed three plateaus, one between 400-450 mV, another at 150 mV, and the last at 110 mV before precipitating metallic lithium at 0 V after accepting 240 μAh/(cm²×μm) of lithium from the lithium counter electrode. Cycling the Li₁V₂O₅ electrode down to 0 V was well reversible and the electrode remained x-ray amorphous throughout its entire operational life.

A solid-state thin-film lithium-ion anode battery may be constructed with a Li₁V₂O₅ lithium-ion negative anode and a crystalline LiCoO₂ positive cathode. Onto the substrate (which may be an approximately 250 μm thick alumina plate) may be deposited an approximately 0.03 μm thick Cr adhesion layer (which may be electron beam evaporated), on that an approximately 0.3 μm thick Au current collector (which may be electron beam evaporated), on that an approximately 2.1 μm LiCoO₂ positive cathode (which may be RF magnetron sputter deposited from a LiCoO₂ target in argon atmosphere followed by post-deposition anneal at approximately 700° C. in air for about 1 h), on that a 1.5 μm Lipon (which may be deposited as previously described) solid state electrolyte, on that an approximately 0.3 μm thick Li₁V₂O₅ lithium-ion negative anode, and on that an approximately 0.3 μm thick Cu anode current collector (which may be DC magnetron sputter deposited in argon sputter gas atmosphere).

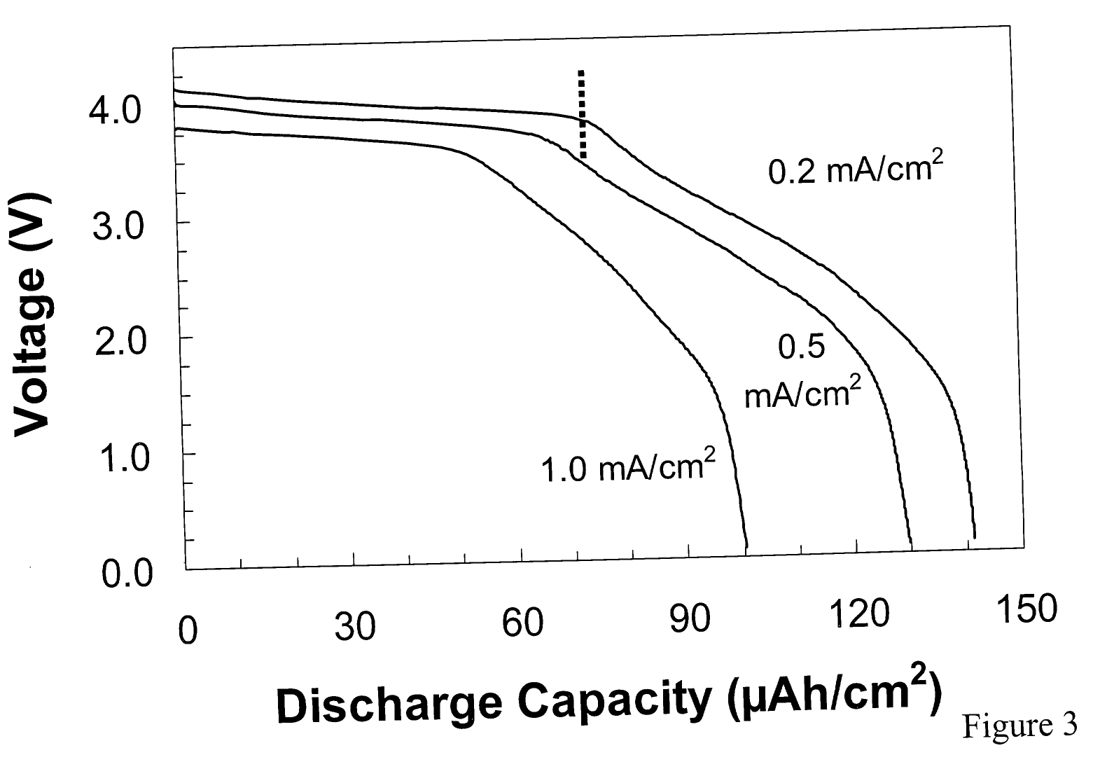

Such a battery (in this example, having a 1 cm² active area) was cycled in the voltage range between approximately 4.2 and 0.1 V at current densities up to about 1.0 mA/cm² active Li₁V₂O₅ battery area at about 21° C. in a hermetically sealed stainless steel tube equipped with feed-throughs and filled with an argon atmosphere (overall impurity level below 10 ppm). The discharge voltage profiles are shown in FIG. 3. During the long plateaus in the 4 V region the Li₁V₂O₅ lithium-ion anode was discharging its precipitated metallic lithium first before releasing the lithium ions and electrons that were stored in its actual lithium vanadium structure. For the 0.2 mA/cm² discharge profile, the composition at 4.2 V was 5.4 metallic Li and Li₆₄V₂O₅ (two-phase electrode), at the dashed line the overall stoichiometry was Li_{6.4}V₂O₅, and at 0.1 V the original composition of Li₁V₂O₅ was reached again (the as-fabricated voltage of the battery was +0.1 V at LiCoO₂). This example demonstrates the excellent lithium-ion anode characteristics of Li₁V₂O₅ even when overlithiated (Li_{6.4}V₂O₅ yields 0 V vs. Li⁺/Li).

A twin lithium vanadium oxide electrode battery may be constructed based on the very different capacities per unit area and unit thickness at 0.2 mA/cm² of the Li₁V₂O₅ lithium-ion anode (230 μAh/(cm²×μm)) and the Li₂V₂O₅ cathode (17 μAh/(cm²×μm)). For example, a twin lithium vanadium oxide electrode battery may be constructed with the Li₂V₂O₅ electrode about thirteen times thicker than the Li₁V₂O₅ electrode. To charge such a battery lithium ions (and electrons) may be transferred from the Li₂V₂O₅ electrode through the electrolyte (and the external circuit) to the Li₁V₂O₅ electrode. Thus, the Li₂V₂O₅ may increase its voltage and reach 3.8 V vs. Li⁺/Li at about Li₀V₂O₅ while the Li₁V₂O₅ electrode concurrently decreases in voltage and eventually reaches 0 V vs. Li⁺/Li at about Li_{6.4}V₂O₅. In such a state this example battery is charged (3.8 V battery voltage) and may be discharged down to 0 V. At 0 V both electrodes are reaching the same stoichiometry and potential vs. Li⁺/Li. After discharge the battery may be recharged in the same fashion. Thus, the negative lithium-ion anode may reach a stoichiometry of about Li_{6.4}V₂O₅ and the positive cathode of about Li₀V₂O₅.

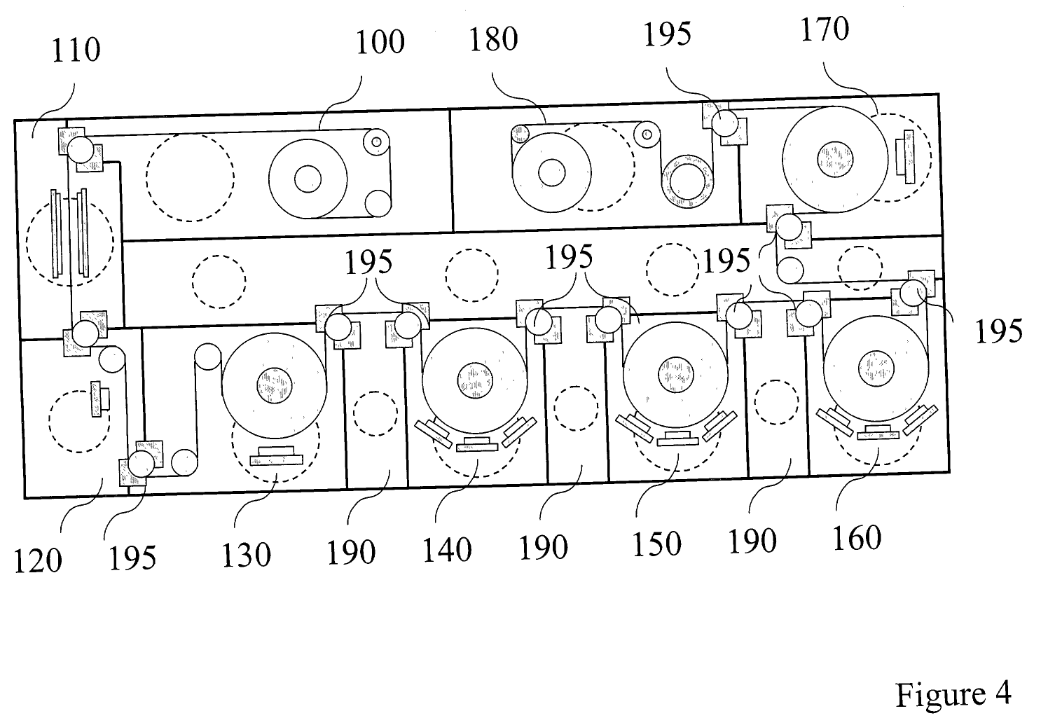

A twin lithium vanadium oxide battery may, for example, be fabricated by a web coating process, as depicted, for example, in FIG. 4. The process is described in terms of a segment of the substrate as it is wound from a first chamber 100 to a last chamber 180. First, the web substrate (which may be for example, metallic or polymeric) may be conditioned. For example, the first chamber 100 may serve to outgas the surface of the polymer web. This outgassing step and the next step may not be important if a metallic substrate is used. Subsequently, an infrared web bakeout may be performed in a second chamber 110 to further outgas the surface and bulk material web impurities. In a third chamber 120 a glow discharge pretreatment for the web surface may be required to chemically and/or mechanically modify surface the properties of the web to enable adhesion of the first layer, which may be the thin-film current collector. Following this step, all battery layers (for example, five layers) may be sequentially deposited while the web is traveling through the in-line system. The first layer, which may be a metal anode current collector (which may, for example, be Cu, Cr, Co, Au, or Ag), may be deposited in a fourth chamber 130. The second layer, which may be the prospective lithium-ion anode (which may be, for example, Li₁V₂O₅), may be deposited in a fifth chamber 140. The third layer, which may be the Lipon electrolyte, may be deposited in a sixth chamber 150. The prospective cathode (which may be Li₂V₂O₅) may be deposited in a seventh chamber 160. The fifth layer, which may be the metallic cathode current collector (which may be, for example, Cu, Cr, Co, Au, or Ag) may be applied in a eighth chamber 170. Between deposition zones such as chambers 130, 140, 150, 160, and 170, there may be, for example, buffer chambers 190 which may serve to isolate reactive and non-reactive deposition gas precursors such as O₂, N₂, and Ar from other simultaneous depositions. Conductance rollers 195 at the web entrances and exits in the deposition chambers may provide further isolation and enable thin-film layer specific pressure level capability and containment. If a metallic web based substrate is employed, such as stainless steel, the first layer (metallic anode current collector) may be undesired, and thus, may be omitted. Optional metallic substrate insulators may be deposited underneath the first layer if desired. An optional encapsulation layer may be deposited after the fifth layer to prepare the battery for long term air exposure. After all depositions are complete, the now-laden web may be stored in the final chamber 180.

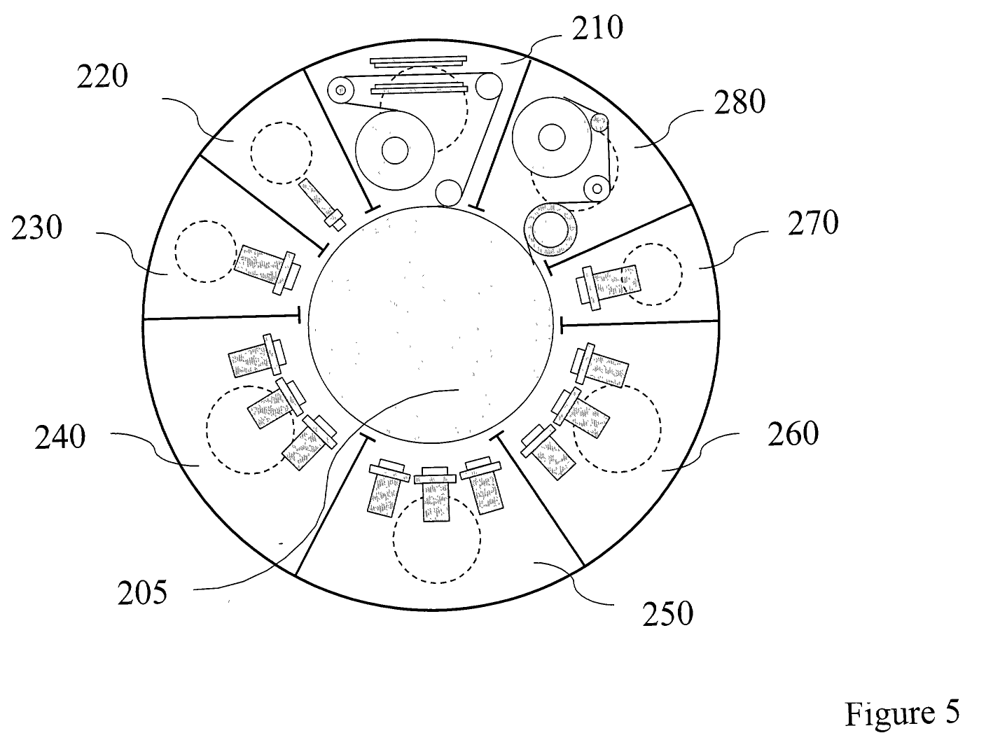

A twin lithium vanadium oxide battery may, for example, be fabricated by a drum coating process, as depicted, for example, in FIG. 5. This process is analogous to the web coating process described in FIG. 4. The process is described in terms of a segment of the substrate as it is wound from a first chamber 210 about a drum 205 to a last chamber 280. First, the web (which may be, for example, metallic or polymeric) substrate may be conditioned. For example, a first chamber 210 may serve to outgas the surface of the polymer web and may also be used to perform an infrared web bakeout. This step may not be important if a metallic substrate is used. In a second chamber 220 a glow discharge pretreatment for the web surface may be required to chemically and/or mechanically modify surface properties of the web to enable adhesion of the first layer, which may be the thin-film current collector. Following this step, all, such as for example five, battery layers may be sequentially deposited while the web is traveling through the in-line system. The first layer, which may be a metal anode current collector (which may, for example, be Cu, Cr, Co, Au, or Ag), may be deposited in a third chamber 230. The second layer, which may be the prospective lithium-ion anode (which may be, for example, Li₁V₂O₅) may be deposited in a fourth chamber 240. The third layer, which may be the Lipon electrolyte, may be deposited in a fifth chamber 250. The prospective cathode (which may be Li₂V₂O₅), may be deposited in a sixth chamber 260. The fifth layer, which may be the metallic cathode current collector (which may be, for example, Cu, Cr, Co, Au, or Ag) may be applied in a seventh chamber 270. If a metallic web based substrate is employed, such as stainless steel, the first layer (metallic anode current collector) may be undesired, and thus may be omitted. Optional metallic substrate insulators may be deposited before the first layer if desired. An optional encapsulation layer may be deposited after the fifth layer to prepare the battery for long term air exposure. After all depositions are complete, the now-laden web may be stored in the final chamber 180.

An electrochromic cell may be fabricated according to the present invention. For example, a layer of LiₓV₂O_{y} (0<x≦100, 0<y≦5) may be deposited on a suitable substrate. Next, a layer of electrolyte may be deposited on the layer of LiₓV₂O_{y}. Finally, one may deposit an electrochromic electrode such as WO₃. Thus, the LiₓV₂O_{y} may serve as a very suitable counter electrode in an electrochromic cell of the present invention. In such an electrochromic cell, there is no requirement that the electrochromic electrode be fabricated with any lithium ions and electrons, as LiₓV₂O_{y} may bring all the required electrochemically active Li into the electrochromic cell.

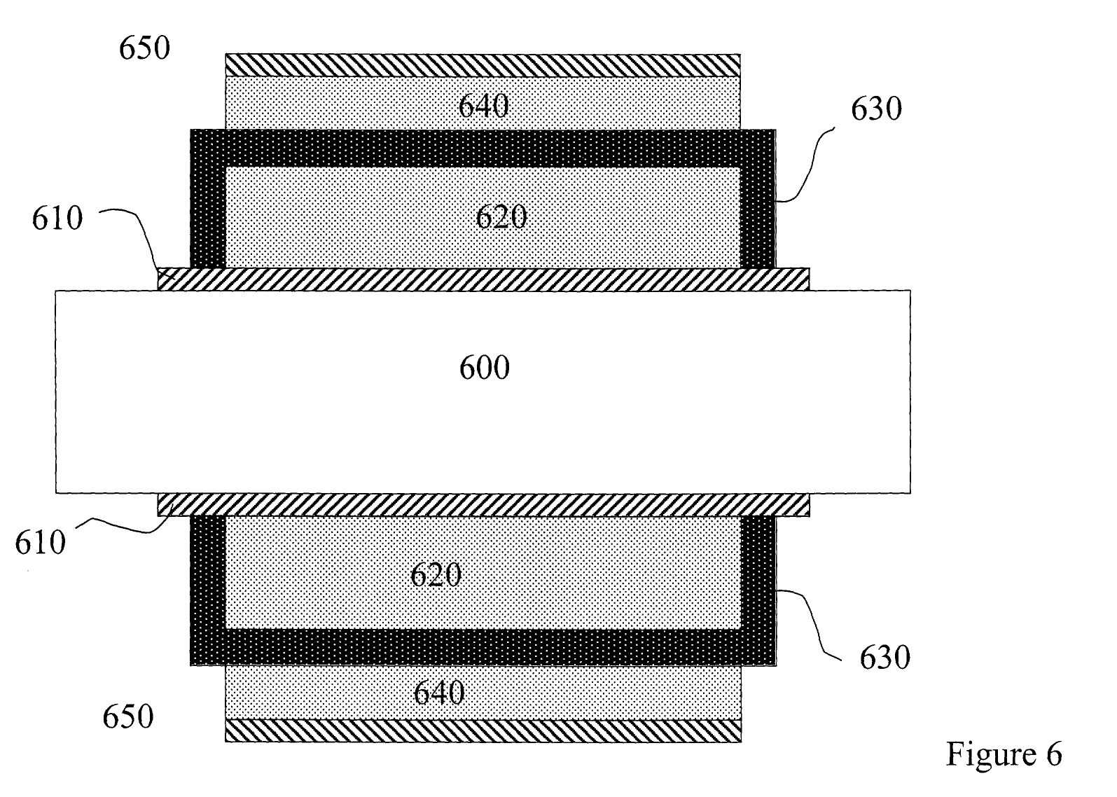

FIG. 6 is a cutaway diagram of an embodiment of the present invention employing a twin LiₓV₂O_{y} electrode battery design. In this embodiment, a substrate 600 may be employed that may be, for example, a foil or fibrous substrate. On this substrate, a layer of cathode current collector (ccc) 610 may be applied. A first LiₓV₂O_{y} electrode layer 620 may be deposited on ccc 610. An electrolyte layer 630 may be deposited on first LiₓV₂O_{y} electrode layer 620. A second LiₓV₂O_{y} electrode layer 640 may be deposited on electrolyte layer 630. Finally an anode current collector (acc) layer 650 may be deposited on second LiₓV₂O_{y} electrode layer 640. The entire battery device as shown, for example, in FIG. 6 may be encapsulated with a protective matrix (not shown).

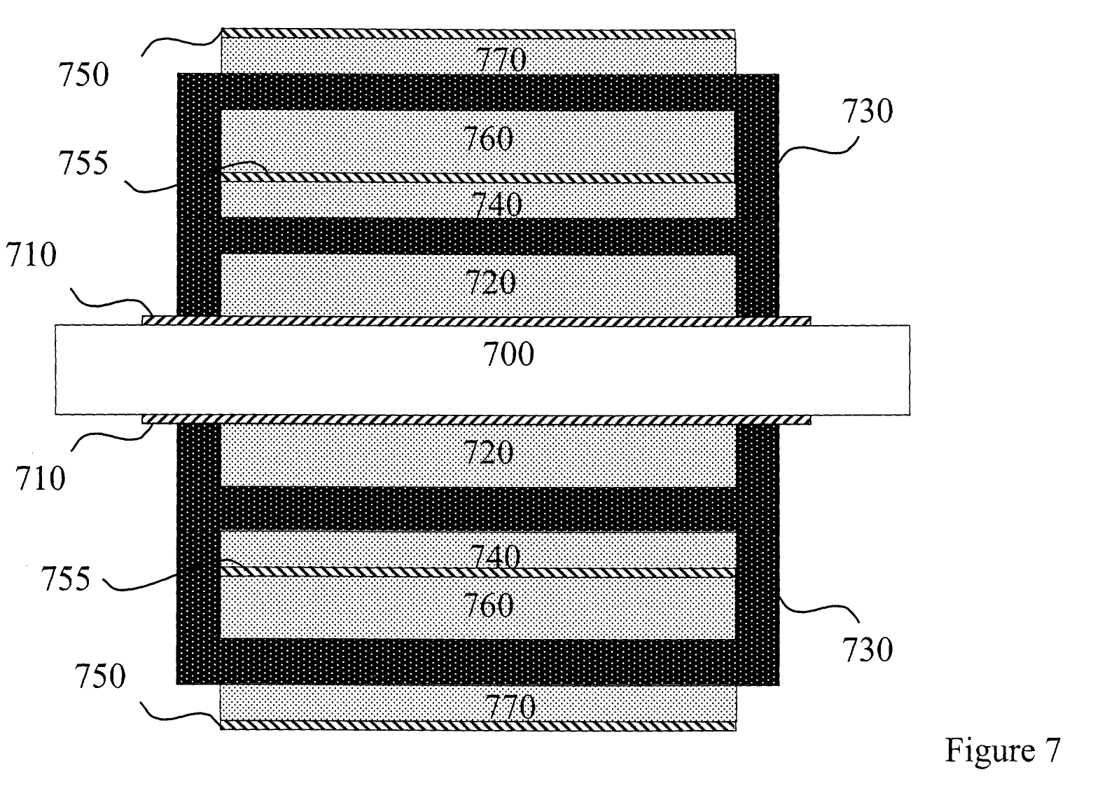

FIG. 7 is a cutaway diagram of an embodiment of the present invention employing two twin LiₓV₂O_{y} electrode batteries connected in series. In this embodiment, for example, a substrate 700 may be employed that may be a foil or fiber. On substrate 700, a ccc layer 710 may be applied. On the ccc layer 710, a first LiₓV₂O electrode layer 720 may be deposited. On first LiₓV₂O_{y} electrode layer 720, a layer of electrolyte 730 may be applied. A second LiₓV₂O_{y} electrode layer 740 may be deposited on the layer of electrolyte 730. Next a conductive layer 755 may be deposited on the second LiₓV₂O_{y} electrode layer 740. Then, a third LiₓV₂O_{y} electrode layer 760 may be deposited on the conductive layer 755. Next, another portion of the layer of electrolyte 730 may be applied to the third LiₓV₂O_{y} electrode layer 760. Next, a fourth LiₓV₂O_{y} electrode layer 770 may be deposited on the layer of electrolyte 730. Finally an acc layer 750 may be deposited on the fourth LiₓV₂O_{y} electrode layer 770. The entire battery device as shown, for example, in FIG. 7 may be encapsulated with a protective matrix (not shown).

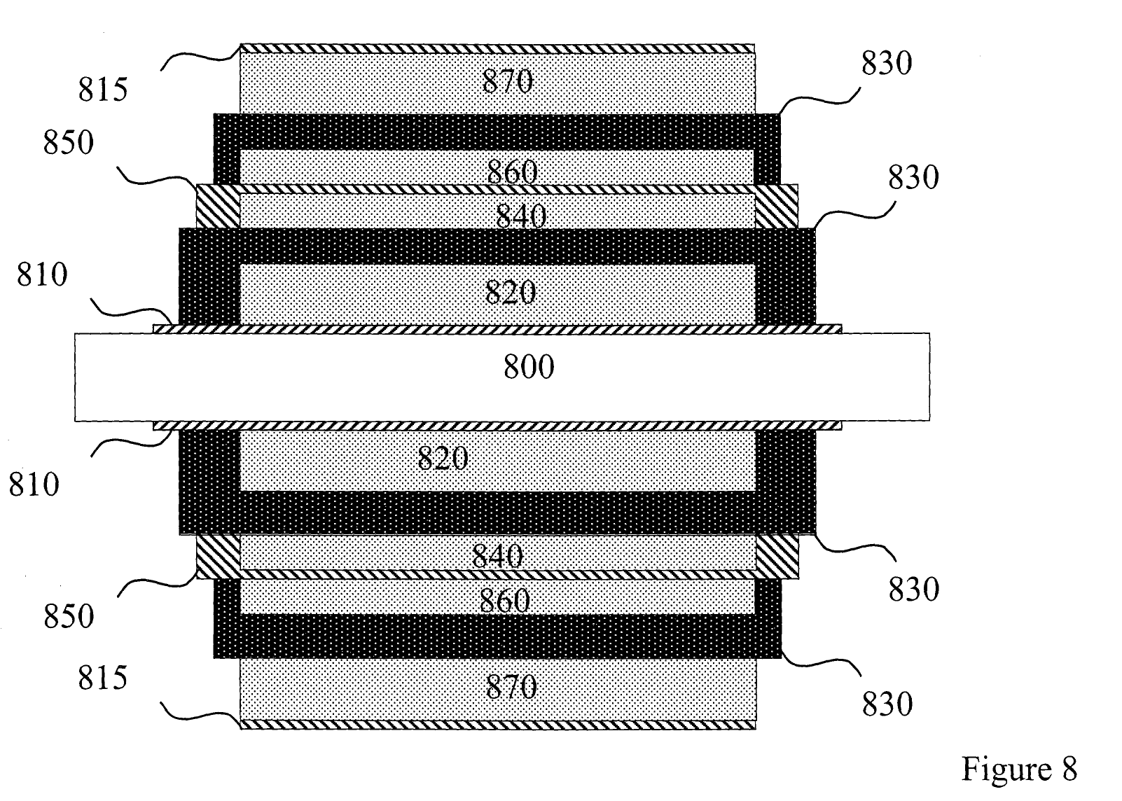

FIG. 8 is a cutaway diagram of an embodiment of the present invention employing two twin LiₓV₂O_{y} electrode batteries connected in parallel. In this embodiment, for example, a substrate 800 may be employed that may be a foil or fiber. On substrate 800, a first ccc layer 810 may be applied. On first ccc layer 810, a first LiₓV₂O_{y} electrode layer 820 may be deposited. On first LiₓV₂O_{y} electrode layer 820, a layer of electrolyte 830 may be applied. A second LiₓV₂O_{y} electrode layer 840 may be deposited on the layer of electrolyte 830. Next an acc layer 850 may be deposited on the second LiₓV₂O_{y} electrode layer 840. Then, a third LiₓV₂O_{y} electrode layer 860 may be deposited on the acc layer 850. Next, another portion of the layer of electrolyte 830 may be applied to the third LiₓV₂O_{y} electrode layer 860. Next a fourth LiₓV₂O_{y} electrode layer 870 may be deposited on the layer of electrolyte 830. Finally a second ccc layer 815 may be deposited on the fourth LiₓV₂O_{y} electrode layer 870. The entire battery device as shown, for example, in FIG. 8 may be encapsulated with a protective matrix (not shown).

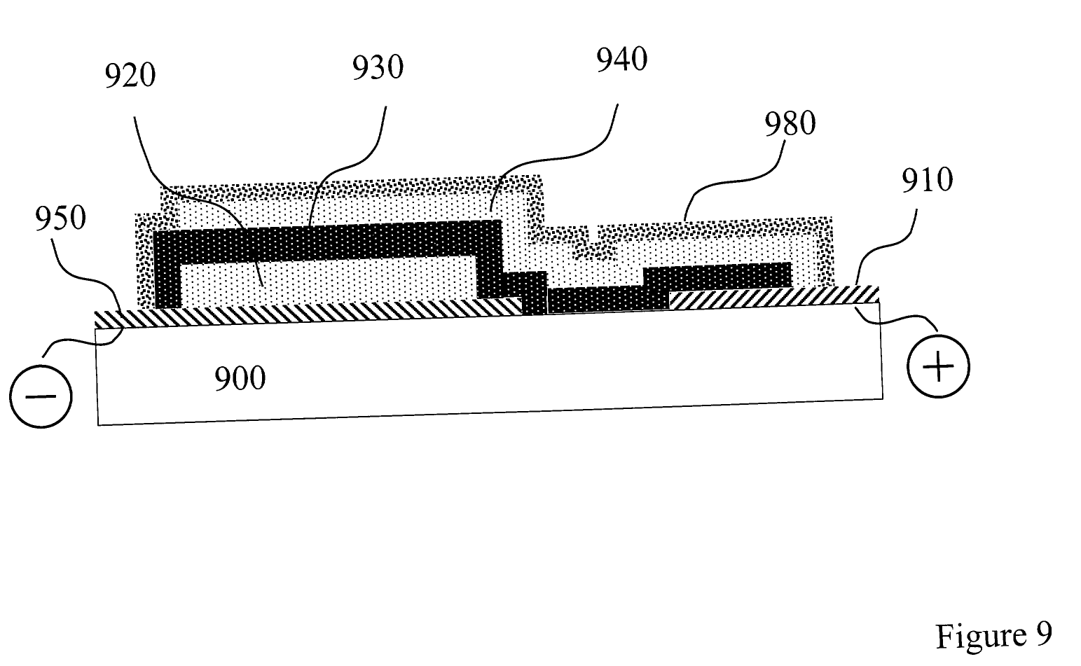

FIG. 9 is a cutaway side-view diagram of an embodiment of the present invention employing a twin LiₓV₂O_{y} electrode battery on an insulating substrate. In this embodiment, a substrate 900 may be provided. Substrate 900 may, for example, be an insulating plate, foil, or thick film. On portions of substrate 900, an acc 950 and a ccc 910 may be deposited. On acc 950, a first LiₓV₂O_{y} electrode layer 920 may be deposited. A layer of electrolyte 930 may be deposited on first LiₓV₂O_{y} electrode layer 920. A second LiₓV₂O_{y} electrode layer 940 may deposited on the electrolyte layer 930. Finally an overlayer 980, which may function as an encapsulant, may be deposited on second LiₓV₂O_{y} electrode layer 940.

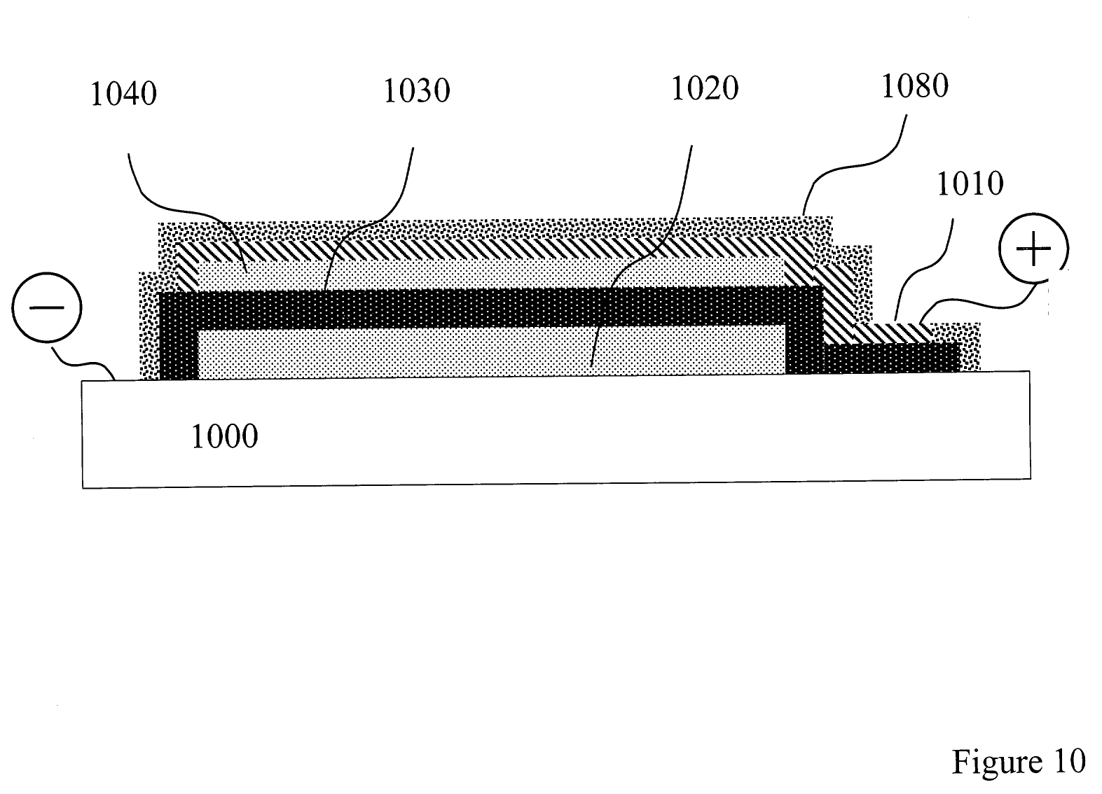

FIG. 10 is a cutaway side-view diagram of an embodiment of the present invention employing a twin LiₓV₂O_{y} electrode battery on a conducting substrate. In this embodiment, a substrate 1000 may be provided. Substrate 1000 may, for example, be an conducting plate, foil, or thick film and may function as the acc of the battery. On substrate 1000, a first LiₓV₂O_{y} electrode layer 1020 may be deposited. A layer of electrolyte 1030 may be deposited on first LiₓV₂O_{y} electrode layer 1020. A second LiₓV₂O_{y} electrode layer 1040 may deposited on the layer of electrolyte 1030. A ccc layer 1010 may be deposited on second LiₓV₂O_{y} electrode layer 1040 and on a portion of the layer of electrolyte 1030. Finally an overlayer 1080, which may function as an encapsulant, may be deposited on a portion of ccc layer 1010.

Other embodiments of the invention will be apparent to those skilled in the art from consideration of the specification and the practice of the invention disclosed herein. It is intended that the specification and examples be considered as exemplary only, with a true scope and spirit of the invention being indicated by the following claims.

What is claimed is:

1. A method of fabricating an as-deposited lithiated vanadium oxide film comprising the steps of:
providing a source comprising an approximate overall composition of LiₓV₂O_{y}, wherein 0<x≦100 and 0<y≦5, and
vacuum depositing said source,
wherein said source comprises at least two of the group consisting of Li₃VO₄, LiVO₃, and V₂O₃.

2. The method of claim 1, wherein said step of vacuum depositing comprises a technique selected from a group consisting of reactive magnetron sputtering, non-reactive magnetron sputtering, reactive diode sputtering, non-reactive diode sputtering, reactive electron beam evaporation, non-reactive electron beam evaporation, reactive electron beam directed vapor deposition, non-reactive electron beam directed vapor deposition, reactive plasma enhanced electron beam directed vapor deposition, non-reactive plasma enhanced electron beam directed vapor deposition, reactive thermal evaporation, non-reactive thermal evaporation, plasma assisted thermal evaporation, cathodic arc deposition, ion beam deposition, plasma assisted ion beam deposition, pulsed laser deposition, chemical vapor deposition, and plasma enhanced chemical vapor deposition.

3. The method of claim 1, wherein said source comprises a target, and said step of vacuum depositing comprises sputter depositing.

4. The method of claim 3, wherein said target comprises a plurality of separate targets.

5. The method of claim 3, wherein said target comprises a plurality of segments.

6. The method of claim 3, further comprising the step of adjusting an oxygen to lithium and vanadium ratio in a product of said step of sputter depositing said target by annealing said product in an appropriate gas atmosphere with a temperature greater than about −195.8° C.

7. The method of claim 3, further comprising the step of adjusting an oxygen to lithium and vanadium ratio in a product of said step of sputter depositing said target by sputter depositing said target in an atmosphere containing an appropriate O₂ partial pressure.

8. The method of claim 6, wherein said temperature is greater than about 20° C.

9. The method of claim 8, wherein said temperature is greater than about 10° C.

10. The method of claim 3, wherein said step of sputter depositing comprises depositing a film comprising one or more phases of a type selected from a group consisting of glassy, amorphous, nano-crystalline, and crystalline.

11. The method of claim 3, wherein said step of sputter depositing comprises depositing a film having a thickness of between about 0.005 microns and about 20 microns.

12. The method of claim 3, wherein said step of sputter depositing comprises depositing a film having a thickness of between about 0.005 microns and about 5 microns.

13. The method of claim 3, further comprising providing supplemental target material to said target.

14. The method of claim 13, wherein said supplemental target material comprises a material selected from a group consisting of Li₃N, Li₂O, Li₂O₂, and Li.

15. The method of claim 14, wherein said supplemental target material further comprises a doping material and wherein said doping material comprises a material selected from a group consisting of H, Be, Na, Mg, K, Ca, Rb, Sr, Cs, Ba, Al, Si, P, Ga, Ge, As, In, Sn, Sb, Tl, Pb, Bi, Sc, Ti, Cr, Mn, Fe, Co, Ni, Zn, Y, Zr, Nb, Mo, La, Hf, Ta, W, and Ce.

16. The method of claim 13, wherein said step of providing supplemental target material comprises placing pellets on said target.

17. The method of claim 13, wherein said step of providing supplemental target material comprises providing said supplemental target material in precut grooves in said target.

18. The method of claim 13, wherein said step of providing supplemental target material comprises providing said supplemental target material in a segment of said target.

19. The method of claim 13, wherein said supplemental target material comprises a material selected from a group consisting of vanadium metal and V₂O₃.

20. An apparatus for use as a solid-state thin-film battery comprising
a substrate,
a cathode layer on said substrate, and
an electrolyte layer on said cathode layer, wherein said cathode layer comprises LiₓV₂O_{y}, wherein 0<x≦100 and 0<y≦5.

21. The apparatus of claim 20, further comprising an anode layer on said electrolyte layer.

22. The apparatus of claim 21, wherein said anode layer comprises a material selected from a group consisting of Mg, B, Al, Ga, In, Tl, C, Si, Ge, Sn, Pb, P, As, Sb, Bi, Pd, Zn, Cd, Ag, Ir, Pt, Au, Li₄Ti₅O₁₂, lithium cobalt nitride, lithium manganese nitride, SnNₓ (0<x≦1.33), InNₓ (0<x≦1.0), ZnNₓ (0<x≦0.67), CuNₓ (0<x≦0.33), NiNₓ (0<x≦0.33), silicon tin oxynitride, SnOₓ (0<x≦2.0), InOₓ (0<x≦1.5), and PbOₓ (0<x≦2.0).

23. The apparatus of claim 21, wherein said anode layer comprises a metallic lithium anode layer.

24. The apparatus of claim 20, wherein said substrate comprises a form selected from a group consisting of foil, sheet, plate, ribbon, and round.

25. The apparatus of claim 20, wherein said substrate comprises a material selected from a group consisting of a metal, an alloy, polyester, polyimide, polyamide, polycarbonate, polyurethane, polyalcohol, rubber, silicone, a ceramic, a semi-conductor, silicon, graphite, and glass.

26. The apparatus of claim 20, further comprising a barrier layer between said substrate and said cathode layer.

27. The apparatus of claim 26, wherein said barrier layer comprises a material selected from a group consisting of Lipon, graphitic carbon, diamond-like carbon, aluminum nitride, aluminum oxynitride, aluminum oxide, silicon nitride, silicon oxynitride, silicon monoxide, silicon dioxide, silicon carbide, titanium nitride, titanium oxynitride, titanium boride, titanium silicide, titanium carbide, vanadium nitride, vanadium carbide, vanadium silicide, vanadium boride, chromium nitride, chromium carbide, chromium boride, chromium silicide, yttrium nitride, yttrium carbide, yttrium boride, yttrium silicide, zirconium nitride, zirconium carbide, zirconium boride, zirconium silicide, niobium nitride, niobium carbide, niobium boride, niobium suicide, molybdenum nitride, molybdenum carbide, molybdenum boride, molybdenum silicide, hafnium nitride, hafnium carbide, hafnium boride, hafnium silicide, tantalum nitride, tantalum carbide, tantalum boride, tantalum silicide, tungsten nitride, tungsten carbide, tungsten boride, and tungsten silicide.

28. The apparatus of claim 20, further comprising a cathode current collector layer beneath said cathode layer.

29. The apparatus of claim 28, wherein said cathode current collector layer comprises a material selected from a group consisting of Al, Ti, V, Cr, Mn, Fe, Co, Ni, Cu, Zn, Pd, Ag, Ir, Pt, Au, CuSn, phosphor bronze, and stainless steel.

30. The apparatus of claim 21, further comprising an anode current collector layer on said anode layer.

31. The apparatus of claim 20, further comprising an anode current collector layer on said electrolyte layer.

32. The apparatus of claim 30, wherein said anode current collector layer comprises a material selected from a group consisting of Sc, Ti, V, Cr, Mn, Fe, Co, Ni, Cu, Nb, Mo, Hf, Ta, W, CuSn, phosphor bronze, and stainless steel.

33. The apparatus of claim 21, wherein said anode layer comprises a film comprising one or more phases of a type selected from a group consisting of glassy, amorphous, nano-crystalline, and crystalline.

34. The apparatus of claim 20, wherein said electrolyte layer comprises a thickness of about 0.1 microns to about 100 microns.

35. The apparatus of claim 20, wherein said electrolyte layer comprises a solid-state material selected from a group consisting of LiAlF₄, LiAlCl₄, and polymer lithium electrolyte.

36. The apparatus of claim 20, wherein said electrolyte layer comprises a non-aqueous liquid lithium electrolyte.

37. The apparatus of claim 36, wherein said electrolyte layer further comprises a solid-state separator.

38. The apparatus of claim 20, wherein said cathode layer comprises a film having a thickness of between about 0.005 microns and about 20 microns.

39. The apparatus of claim 20, wherein said cathode layer comprises a film having a thickness of between about 0.005 microns and about 5 microns.

40. An apparatus for use as a solid-state thin-film battery comprising
a substrate,
an electrolyte layer on said substrate, and
a cathode layer on said electrolyte layer, wherein said cathode layer comprises LiₓV₂O_{y}, wherein 0<x≦100 and 0<y≦5.

41. The apparatus of claim 40, further comprising a barrier layer between said substrate and said electrolyte layer.

42. The apparatus of claim 40, further comprising a cathode current collector layer on said cathode layer.

43. The apparatus of claim 40, further comprising an anode current collector layer between said substrate and said electrolyte layer.

44. The apparatus of claim 40, wherein said cathode layer comprises a film comprising one or more phases of a type selected from a group consisting of glassy, amorphous, nano-crystalline, and crystalline.

45. The apparatus of claim 40, wherein said cathode layer comprises a film having a thickness of between about 0.005 microns and about 20 microns.

46. The apparatus of claim 40, wherein said cathode layer comprises a film having a thickness of between about 0.005 microns and about 5 microns.

47. The apparatus of claim 40, further comprising an anode layer between said substrate and said electrolyte layer.

48. The apparatus of claim 47, wherein said anode layer comprises an anode layer selected from a group consisting of a lithium-free anode layer, a lithium-ion anode layer, and a metallic lithium anode layer.

49. An apparatus for use as a solid-state thin-film battery comprising
a substrate,
a cathode layer on said substrate,
an electrolyte layer on said cathode layer, and
an anode layer on said electrolyte layer, wherein said anode layer comprises LiₓV₂O_{y}, wherein 0<x≦100 and 0<y≦5.

50. The apparatus of claim 49, wherein said cathode layer comprises a material selected from a group consisting of LiCoO₂, LiNiO₂, LiMn₂O₄, LiₓMn_{2-y}O₄ (1.2<x<2.2, y≈0.3), LiFePO₄, LiVOPO₄, LiTiS₂, LiMnCrO₄, LiCo₁₋ₓAlₓO₂ (0≦x≦1), V₂O₅, V₆O₁₃, VO₂, MnO₂, FePO₄, VOPO₄, TiS₂, and MnO_{0 5}Cr_{0.5}O₂.

51. The apparatus of claim 49, further comprising a barrier layer between said substrate and said cathode layer.

52. The apparatus of claim 49, further comprising a cathode current collector layer beneath said cathode layer.

53. The apparatus of claim 49, further comprising an anode current collector layer on said anode layer.

54. The apparatus of claim 49, wherein said anode layer comprises a film having a thickness of between about 0.005 microns and about 20 microns.

55. The apparatus of claim 49, wherein said anode layer comprises a film having a thickness of between about 0.005 microns and about 5 microns.

56. An apparatus for use as a solid-state thin-film battery comprising
a substrate,
an anode layer on said substrate,
an electrolyte layer on said anode layer, and
a cathode layer on said electrolyte layer, wherein said anode layer comprises LiₓV₂O_{y}, wherein 0<x≦100 and 0<y≦5.

57. The apparatus of claim 56, further comprising a barrier layer between said substrate and said anode layer.

58. The apparatus of claim 56, further comprising a cathode current collector layer on said cathode layer.

59. The apparatus of claim 56, further comprising an anode current collector layer beneath said anode layer.

60. The apparatus of claim 56, wherein said anode layer comprises a film having a thickness of between about 0.005 microns and about 20 microns.

61. The apparatus of claim 56, wherein said anode layer comprises a film having a thickness of between about 0.005 microns and about 5 microns.

62. An apparatus for use as a solid-state thin-film battery comprising
a substrate,
a first electrode layer on said substrate,
an electrolyte layer on said first electrode layer, and
a second electrode layer on said electrolyte layer, wherein said second electrode layer comprises LiₓV₂O_{y}, wherein 0<x≦100 and 0<y≦5 and wherein said first electrode layer comprises LiₓV₂O_{y}, wherein 0<x≦100 and 0<y≦5.

63. The apparatus of claim 62, further comprising a barrier layer between said substrate and said first electrode layer.

64. The apparatus of claim 62, further comprising a current collector layer beneath the first electrode layer.

65. The apparatus of claim 62, further comprising a current collector layer on said second electrode layer.

66. The apparatus of claim 62, wherein said first electrode layer comprises a film comprising one or more phases of a type selected from a group consisting of glassy, amorphous, nano-crystalline, and crystalline.

67. The apparatus of claim 62, wherein said second electrode layer comprises a film comprising one or more phases of a type selected from a group consisting of glassy, amorphous, nano-crystalline, and crystalline.

68. The apparatus of claim 62, wherein said first electrode layer comprises a film having a thickness of between about 0.005 microns and about 20 microns.

69. The apparatus of claim 62, wherein said first electrode layer comprises a film having a thickness of between about 0.005 microns and about 5 microns.

70. The apparatus of claim 62, wherein said second electrode layer comprises a film having a thickness of between about 0.005 microns and about 20 microns.

71. The apparatus of claim 62, wherein said second electrode layer comprises a film having a thickness of between about 0.005 microns and about 5 microns.

72. The apparatus of claim 62, wherein said first electrode layer comprise an electrode selected from a group consisting of a positive cathode and a negative anode.

73. The apparatus of claim 62, wherein said second electrode layer comprise an electrode selected from a group consisting of a positive cathode and a negative anode.

74. An apparatus for use as a solid-state thin-film battery system comprising
a substrate having a first side and a second side,
a first electrode layer on said first side of said substrate,
a first electrolyte layer on said first electrode layer,
a second electrode layer on said first electrolyte layer,
a third electrode layer on said second side of said substrate,
a second electrolyte layer on said third electrode layer, and
a fourth electrode layer on said second electrolyte layer, wherein at least one of said fourth electrode layer, said third electrode layer, said second electrode layer, and said first electrode layer comprises LiₓV₂O_{y}, wherein 0<x≦100 and 0<y≦5.

75. The apparatus of claim 74, wherein said first electrode layer, said first electrolyte layer, and said second electrode layer comprises a first battery, and wherein said third electrode layer, said second electrolyte layer, and said fourth electrode layer comprises a second battery.

76. The apparatus of claim 75, wherein said first battery is adapted to electrically cycle in parallel with said second battery.

77. The apparatus of claim 75, wherein said first battery is adapted to electrically cycle in series with said second battery.

78. An apparatus for use as an electrochromic cell comprising
a substrate,
a layer of LiₓV₂O_{y}, wherein 0<x≦100 and 0<y≦5, on said substrate,
a layer of electrolyte on said layer of LiₓV₂O_{y}, and
a layer of electrochromic electrode on said layer of electrolyte.

79. A method of manufacturing an electrochromic cell comprising
providing a substrate,
vacuum depositing a layer of LiₓV₂O_{y}, wherein 0<x≦100 and 0<y≦5, on said substrate,
depositing a layer of electrolyte on said layer of LiₓV₂O_{y}, and
depositing a layer of electrochromic electrode on said layer of electrolyte.

80. A method of manufacturing a solid-state thin-film battery comprising the steps of
providing a substrate,
depositing a cathode layer on said substrate,
depositing an electrolyte layer on said cathode layer, and
depositing an anode layer on said electrolyte layer, wherein said cathode layer comprises LiₓV₂O_{y}, wherein 0<x≦100 and 0<y≦5.

81. The method of claim 80, further comprising the step of adjusting an oxygen to lithium and vanadium ratio in said cathode layer by annealing said cathode layer in an appropriate gas atmosphere with a temperature greater than about −195.8° C.

82. The method of claim 81, wherein said temperature is greater than about 20° C.

83. The method of claim 82, wherein said temperature is greater than about 100° C.

84. The method of claim 80, wherein said step of depositing a cathode layer comprises a technique selected from the group consisting of reactive magnetron sputtering, non-reactive magnetron sputtering, reactive diode sputtering, non-reactive diode sputtering, reactive electron beam evaporation, non-reactive electron beam evaporation, reactive electron beam directed vapor deposition, non-reactive electron beam directed vapor deposition, reactive plasma enhanced electron beam directed vapor deposition, non-reactive plasma enhanced electron beam directed vapor deposition, reactive thermal evaporation, non-reactive thermal evaporation, plasma assisted thermal evaporation, cathodic arc deposition, ion beam deposition, plasma assisted ion beam deposition, pulsed laser deposition, chemical vapor deposition, plasma enhanced chemical vapor deposition, photo-chemical chemical vapor deposition, and molecular beam epitaxy.

85. The method of claim 80, wherein said cathode layer comprises a film comprising one or more phases of a type selected from a group consisting of glassy, amorphous, nano-crystalline, and crystalline.

86. The method of claim 80, wherein said electrolyte layer comprises a thickness of about 0.1 microns to about 100 microns.

87. The method of claim 80, wherein said electrolyte layer comprises a solid-state material selected from a group consisting of LiAlF₄, LiAlCl₄, and polymer lithium electrolyte.

88. The method of claim 80, wherein said electrolyte layer comprises a non-aqueous liquid lithium electrolyte.

89. The method of claim 88, wherein said electrolyte layer further comprises a solid-state separator.

90. The method of claim 80, wherein said step of depositing a cathode layer comprises depositing a film having a thickness of between about 0.005 microns and about 20 microns.

91. The method of claim 80, wherein said step of depositing a cathode layer comprises depositing a film having a thickness of between about 0.005 microns and about 5 microns.

92. A method of manufacturing a solid-state thin-film battery comprising the steps of
providing a substrate,
depositing an electrolyte layer on said substrate, and
depositing a cathode layer on said electrolyte layer, wherein said cathode layer comprises LiₓV₂O_{y}, wherein 0<x≦100 and 0<y≦5.

93. The method of claim 92, further comprising the step of adjusting an oxygen to lithium and vanadium ratio in said cathode layer by annealing said cathode layer in an appropriate gas atmosphere with a temperature greater than about −195.8° C.

94. The method of claim 93, wherein said temperature is greater than about 20° C.

95. The method of claim 94, wherein said temperature is greater than about 100° C.

96. The method of claim 92, wherein said step of depositing a cathode layer comprises a technique selected from the group consisting of reactive magnetron sputtering, non-reactive magnetron sputtering, reactive diode sputtering, non-reactive diode sputtering, reactive electron beam evaporation, non-reactive electron beam evaporation, reactive electron beam directed vapor deposition, non-reactive electron beam directed vapor deposition, reactive plasma enhanced electron beam directed vapor deposition, non-reactive plasma enhanced electron beam directed vapor deposition, reactive thermal evaporation, non-reactive thermal evaporation, plasma assisted thermal evaporation, cathodic arc deposition, ion beam deposition, plasma assisted ion beam deposition, pulsed laser deposition, chemical vapor deposition, plasma enhanced chemical vapor deposition, photo-chemical chemical vapor deposition, and molecular beam epitaxy.

97. The method of claim 92, wherein said cathode layer comprises a film comprising one or more phases of a type selected from a group consisting of glassy, amorphous, nano-crystalline, and crystalline.

98. The method of claim 92, wherein said electrolyte layer comprises a thickness of about 0.1 microns to about 100 microns.

99. The method of claim 92, wherein said electrolyte layer comprises a solid-state material selected from a group consisting of LiAlF₄, LiAlCl₄, and polymer lithium electrolyte.

100. The method of claim 92, wherein said electrolyte layer comprises a non-aqueous liquid lithium electrolyte.

101. The method of claim 100, wherein said electrolyte layer further comprises a solid-state separator.

102. The method of claim 92, wherein said step of depositing an cathode layer comprises depositing a film having a thickness of between about 0.005 microns and about 20 microns.

103. The method of claim 92, wherein said step of depositing an cathode layer comprises depositing a film having a thickness of between about 0.005 microns and about 5 microns.

104. The method of claim 92, further comprising the step of depositing an anode layer on said substrate between said steps of providing a substrate and depositing an electrolyte layer.

105. A method of manufacturing a solid-state thin-film battery comprising the steps of
providing a substrate,
depositing a cathode layer on said substrate,
depositing an electrolyte layer on said cathode layer, and
depositing an anode layer on said electrolyte layer, wherein said anode layer comprises LiₓV₂O_{y}, wherein 0<x≦100 and 0<y≦5.

106. The method of claim 105, wherein said cathode layer comprises a material selected from a group consisting of LiCoO₂, LiNiO₂, LiMn₂O₄, LiₓMn_{2-y}O₄ (1.2<x<2.2, y≈0.3), LiFePO₄, LiVOPO₄, LiTiS₂, LiMnCrO₄, LiCo₁₋ₓAlₓO₂ (0≦x≦1), V₂O₅, V₆O₁₃, VO₂, MnO₂, FePO₄, VOPO₄, TiS₂, or Mn_{0.5}Cr_{0.5}O₂.

107. The method of claim 105, further comprising the step of adjusting an oxygen to lithium and vanadium ratio in said anode layer by annealing said anode layer in an appropriate gas atmosphere with a temperature greater than about −195.8° C.

108. The method of claim 107, wherein said temperature is greater than about 20° C.

109. The method of claim 108, wherein said temperature is greater than about 100° C.

110. The method of claim 105, wherein said step of depositing an anode layer comprises a technique selected from the group consisting of reactive magnetron sputtering, non-reactive magnetron sputtering, reactive diode sputtering, non-reactive diode sputtering, reactive electron beam evaporation, non-reactive electron beam evaporation, reactive electron beam directed vapor deposition, non-reactive electron beam directed vapor deposition, reactive plasma enhanced electron beam directed vapor deposition, non-reactive plasma enhanced electron beam directed vapor deposition, reactive thermal evaporation, non-reactive thermal evaporation, plasma assisted thermal evaporation, cathodic arc deposition, ion beam deposition, plasma assisted ion beam deposition, pulsed laser deposition, chemical vapor deposition, plasma enhanced chemical vapor deposition, photo-chemical chemical vapor deposition, and molecular beam epitaxy.

111. The method of claim 105, wherein said anode layer comprises a film comprising one or more phases of a type selected from a group consisting of glassy, amorphous, nano-crystalline, and crystalline.

112. The method of claim 105, wherein said electrolyte layer comprises a thickness of about 0.1 microns to about 100 microns.

113. The method of claim 105, wherein said electrolyte layer comprises a solid-state material selected from a group consisting of LiAlF₄, LiAlCl₄, and polymer lithium electrolyte.

114. The method of claim 105, wherein said electrolyte layer comprises a non-aqueous liquid lithium electrolyte.

115. The method of claim 114, wherein said electrolyte layer further comprises a solid-state separator.

116. The method of claim 105, wherein said step of depositing an anode layer comprises depositing a film having a thickness of between about 0.005 microns and about 20 microns.

117. The method of claim 105, wherein said step of depositing an anode layer comprises depositing a film having a thickness of between about 0.005 microns and about 5 microns.

118. A method of manufacturing a solid-state thin-film battery comprising the steps of
providing a substrate,
depositing an anode layer on said substrate,
depositing an electrolyte layer on said anode layer, and
depositing a cathode layer on said electrolyte layer, wherein said anode layer comprises LiₓV₂O_{y}, wherein 0<x≦100 and 0<y≦5.

119. The method of claim 118, wherein said cathode layer comprises a material selected from a group consisting of LiCoO₂, LiNiO₂, LiMn₂O₄, LiₓMn_{2-y}O₄ (1.2<x<2.2, y≈0.3), LiFePO₄, LiVOPO₄, LiTiS₂, LiMnCrO₄, LiCoO₁₋ₓAlₓO₂ (0≦x≦1), V₂O₅, V₆O₁₃, VO₂, MnO₂, FePO₄, VOPO₄, TiS₂, or Mn_{0.5}Cr_{0.5}O₂.

120. The method of claim 118, further comprising the step of adjusting an oxygen to lithium and vanadium ratio in said anode layer by annealing said anode layer in an appropriate gas atmosphere with a temperature greater than about −195.8° C.

121. The method of claim 120, wherein said temperature is greater than about 20° C.

122. The method of claim 121, wherein said temperature is greater than about 100° C.

123. The method of claim 118, wherein said step of depositing an anode layer comprises a technique selected from the group consisting of reactive magnetron sputtering, non-reactive magnetron sputtering, reactive diode sputtering, non-reactive diode sputtering, reactive electron beam evaporation, non-reactive electron beam evaporation, reactive electron beam directed vapor deposition, non-reactive electron beam directed vapor deposition, reactive plasma enhanced electron beam directed vapor deposition, non-reactive plasma enhanced electron beam directed vapor deposition, reactive thermal evaporation, non-reactive thermal evaporation, plasma assisted thermal evaporation, cathodic arc deposition, ion beam deposition, plasma assisted ion beam deposition, pulsed laser deposition, chemical vapor deposition, plasma enhanced chemical vapor deposition, photo-chemical chemical vapor deposition, and molecular beam epitaxy.

124. The method of claim 118, wherein said anode layer comprises a film comprising one or more phases of a type selected from a group consisting of glassy, amorphous, nano-crystalline, and crystalline.

125. The method of claim 118, wherein said electrolyte layer comprises a thickness of about 0.1 microns to about 100 microns.

126. The method of claim 118, wherein said electrolyte layer comprises a solid-state material selected from a group consisting of LiAlF₄, LiAlCl₄, and polymer lithium electrolyte.

127. The method of claim 118, wherein said electrolyte layer comprises a non-aqueous liquid lithium electrolyte.

128. The method of claim 127, wherein said electrolyte layer further comprises a solid-state separator.

129. The method of claim 118, wherein said step of depositing an anode layer comprises depositing a film having a thickness of between about 0.005 microns and about 20 microns.

130. The method of claim 118, wherein said step of depositing an anode layer comprises depositing a film having a thickness of between about 0.005 microns and about 5 microns.

131. A method of manufacturing a solid-state thin-film battery comprising the steps of
providing a substrate,
depositing a first electrode layer on said substrate,
depositing an electrolyte layer on said first electrode layer, and
depositing a second electrode layer on said electrolyte layer, wherein said second electrode layer comprises LiₓV₂O_{y}, wherein 0<x≦100 and 0<y≦5, and wherein said first electrode layer comprises LiₓV₂O_{y}, wherein 0<x≦100 and 0<y≦5.

132. The method of claim 131, further comprising the step of adjusting an oxygen to lithium and vanadium ratio in said first electrode layer by annealing said first electrode layer in an appropriate gas atmosphere with a temperature greater than about −195.8° C.

133. The method of claim 132, wherein said temperature is greater than about 20° C.

134. The method of claim 133, wherein said temperature is greater than about 100° C.

135. The method of claim 131, further comprising the step of adjusting an oxygen to lithium and vanadium ratio in said second electrode layer by annealing said second electrode layer in an appropriate gas atmosphere with a temperature greater than about −195.8° C.

136. The method of claim 135, wherein said temperature is greater than about 20° C.

137. The method of claim 136, wherein said temperature is greater than about 100° C.

138. The method of claim 131, wherein said step of depositing a first electrode layer comprises a technique selected from the group consisting of reactive magnetron sputtering, non-reactive magnetron sputtering, reactive diode sputtering, non-reactive diode sputtering, reactive electron beam evaporation, non-reactive electron beam evaporation, reactive electron beam directed vapor deposition, non-reactive electron beam directed vapor deposition, reactive plasma enhanced electron beam directed vapor deposition, non-reactive plasma enhanced electron beam directed vapor deposition, reactive thermal evaporation, non-reactive thermal evaporation, plasma assisted thermal evaporation, cathodic arc deposition, ion beam deposition, plasma assisted ion beam deposition, pulsed laser deposition, chemical vapor deposition, plasma enhanced chemical vapor deposition, photo-chemical chemical vapor deposition, and molecular beam epitaxy.

139. The method of claim 131, wherein said step of depositing a second electrode layer comprises a technique selected from the group consisting of reactive magnetron sputtering, non-reactive magnetron sputtering, reactive diode sputtering, non-reactive diode sputtering, reactive electron beam evaporation, non-reactive electron beam evaporation, reactive electron beam directed vapor deposition, non-reactive electron beam directed vapor deposition, reactive plasma enhanced electron beam directed vapor deposition, non-reactive plasma enhanced electron beam directed vapor deposition, reactive thermal evaporation, non-reactive thermal evaporation, plasma assisted thermal evaporation, cathodic arc deposition, ion beam deposition, plasma assisted ion beam deposition, pulsed laser deposition, chemical vapor deposition, plasma enhanced chemical vapor deposition, photo-chemical chemical vapor deposition, and molecular beam epitaxy.

140. The method of claim 131, wherein said first electrode layer comprises a film comprising one or more phases of a type selected from a group consisting of glassy, amorphous, nano-crystalline, and crystalline.

141. The method of claim 131, wherein said second electrode layer comprises a film comprising one or more phases of a type selected from a group consisting of glassy, amorphous, nano-crystalline, and crystalline.

142. The apparatus of claim 131, wherein said electrolyte layer comprises a thickness of about 0.1 microns to about 100 microns.

143. The method of claim 131, wherein said electrolyte layer comprises a solid-state material selected from a group consisting of LiAlF₄, LiAlCl₄, and polymer lithium electrolyte.

144. The method of claim 131, wherein said electrolyte layer comprises a non-aqueous liquid lithium electrolyte.

145. The method of claim 144, wherein said electrolyte layer further comprises a solid-state separator.

146. The method of claim 131, wherein said step of depositing a first electrode layer comprises depositing a film having a thickness of between about 0.005 microns and about 20 microns.

147. The method of claim 131, wherein said step of depositing a first electrode layer comprises depositing a film having a thickness of between about 0.005 microns and about 5 microns.

148. The method of claim 131, wherein said step of depositing a second electrode layer comprises depositing a film having a thickness of between about 0.005 microns and about 20 microns.

149. The method of claim 131, wherein said step of depositing a second electrode layer comprises depositing a film having a thickness of between about 0.005 microns and about 5 microns.

150. A method of manufacturing a solid-state thin-film battery system comprising the steps of
providing a substrate having a first side and a second side,
depositing a first electrode layer on said first side of said substrate,
depositing a first electrolyte layer on said first electrode layer,
depositing a second electrode layer on said first electrolyte layer,
depositing a third electrode layer on said second side of said substrate,
depositing a second electrolyte layer on said third electrode layer, and
depositing a fourth electrode layer on said second electrolyte layer, wherein at least one of said fourth electrode layer, said third electrode layer, said second electrode layer, and said first electrode layer comprises LiₓV₂O_{y}, wherein 0<x≦100 and 0<y≦5.
